(19) United States
(12) Patent Application Publication
(10) Pub. No.: US 2010/0217880 A1
(43) Pub. Date: Aug. 26, 2010

(54) INFORMATION REQUEST AND ACCESS

(75) Inventors: Marcy R. VENEZIA, Canton, MA (US); Eduardo G. Mclntosh, Canton, MA (US)

Correspondence Address: FOLEY & LARDNER LLP, 111 HUNTINGTON AVENUE, 26TH FLOOR, BOSTON, MA, 02199-7610, US

(73) Assignee: Nightingale Group, LLC

(21) Appl. No.: 12/392,605

(22) Filed: Feb. 25, 2009

(51) Int. Cl. G06F 15/173

(52) U.S. Cl. 709/229

(57) ABSTRACT

The technology includes a method and a system for generating a request for information. A communication module receives first information from a first user and transmits a request for second information to a second user. A form control module determines if second information is needed to complete an information form based on the first information and a form parameter associated with the information form and generates the request for second information to the second user based on the determination of the second information and a second access control parameter associated with the second user.

### BACKGROUND

Dynamic form handling systems are available on the world wide web via the internet. These web form are used to complete information for a specific activity. In addition, a manual process is generally utilized to collect information from a plurality of individuals (e.g. students in a school). This manual process is often requested at different times, under different circumstances, and for different purposes. Since the information is generally stored on paper forms and stored in different parts of an institution, easy access to this information is challenging, if not impossible. However, a need exists to improve information request and access in this technology field

### SUMMARY

One approach to information request and access is a method. The method includes receiving, via a communication module, first information from a first user. The method further includes determining, by a form control module, if second information is needed to complete an information form based on the first information and a form parameter associated with the information for. The method further includes generating, by the form control module, a request to a second user for second information based on the determination of the second information and a second access control parameter associated with the second information. The method further includes transmitting, via the communication module, the request for second information to the second user.

Another approach to information request and access is a computer program product. The computer program product is tangibly embodied in an information carrier. The computer program product includes instructions being operable to cause a data processing apparatus to receive first information from a first user. The computer program product further includes instructions being operable to cause a data processing apparatus to determine if second information is needed to complete an information form based on the first information and a form parameter associated with the information form. The computer program product further includes instructions being operable to cause a data processing apparatus to generate a request to a second user for second information based on the determination of the second information and a second access control parameter associated with the second information. The computer program product further includes instructions being operable to cause a data processing apparatus to transmit the request for second information to the second user.

Another approach to information request and access is a system. The system includes a communication module and a form control module. The communication module receives first information from a first user and/or transmits a request for second information to a second user. The form control module determines if second information is needed to complete an information form based on the first information and a form parameter associated with the information form and/or generates the request for second information to the second user based on the determination of the second information and a second access control parameter associated with the second user.

Another approach to information request and access is a system. The system includes means for receiving first information from a first user; means for determining if second information is needed to complete an information form based on the first information and a form parameter associated with the information form; means for generating a request to a second user for second information based on the determination of the second information and a second access control parameter associated with the second information; and means for transmitting the request for second information to the second user.

In other examples, any of the approaches above can include one or more of the following features. The method includes transmitting, via the communication module, the first information to a third user based on a first access control parameter and a transmission request from the third user.

In some examples, the method includes determining, by an access control module, the first access control parameter associated with the first information based on one or more user types associated with one or more users.

In other examples, the one or more user types include a student, a parent, a teacher, an athletic administrator, a school administrator, and/or a healthcare professional.

In some examples, the method includes determining, by a student information module, if a response to the request for the second information from the second user is complete. The method can further include transmitting, via the communication module, a second request for the second information to the second user based on the determination if the second user completed the request for the second information.

In other examples, the method includes receiving, via the communication module, an authentication request from the second user. The method can further include authenticating, by an access control module, the second user based on the authentication request.

In some examples, the method includes receiving, via the communication module, a response to the request for the second information based on the authentication of the second user. The method can further include determining, by the access control module, a second access control parameter for the response to the request for the second information based on the user type associated with the one or more users.

In other examples, the method includes selecting, by a form creation module, the information form from one or more predetermined information forms based on the first information and a user type associated with the first user.

In some examples, the one or more predetermined information forms includes a parent form, a student form, an athletics form, and/or a health form.

In other examples, the method includes generating, by an access control module, a default access control parameter based on an access control template associated with one or more user types of one or more users. The method further includes modifying, by the access control module, the default access control parameter based on an access request from the first user. The method further includes generating, by the access control module, a first access control parameter associated with the first information based on the modified default access control parameter.

In some examples, the method includes generating, by a report generation module, a report based on the first information, a report request from a third user, and a first access control parameter. The method further includes transmitting, via the communication module, the report to the third user based on the report request and the first access control parameter.

In other examples, the system includes the communication module further to transmit the first information to a third user based on a first access control parameter and a transmission request from the third user.

In some examples, the system includes an access control module to determine the first access control parameter associated with the first information based on one or more user types associated with one or more users.

In other examples, the system includes a student information module to determine if a response to the request for the second information from the second user is complete. The system can further include the communication module further to transmit a second request for the second information to the second user based on the determination if the second user completed the request for the second information.

In some examples, the system includes the communication module further to receive an authentication request from the second user. The system further includes an access control module to authenticate the second user based on the authentication request.

In other examples, the system includes the communication module further to receive a response to the request for the second information based on the authentication of the second user. The system further includes the access control module further to determine a second access control parameter for the response to the request for the second information based on the user type associated with the one or more users.

In some examples, the system includes a form creation module to select the information form from one or more predetermined information forms based on the first information and a user type associated with the first user.

In other examples, the system includes an access control module. The access control module can generate a default access control parameter based on an access control template associated with one or more user types of one or more users; modify the default access control parameter based on an access request from the first user; and/or generate a first access control parameter associated with the first information based on the modified default access control parameter.

In some examples, the system includes a report generation module to generate a report based on the first information, a report request from a third user, and a first access control parameter. The system can further include the communication module further to transmit the report to the third user based on the report request and the first access control parameter.

The information request and access techniques described herein can provide one or more of the following advantages. An advantage to the request aspect of the technology is that additional information can be automatically requested and/or verified which increases the efficiency of the system while decreasing the manual workload of the system users (e g., school administrators, parents, teachers, etc.). Another advantage to the request aspect of the technology is that forms can be automated thereby decreasing the time spent on completing the same form throughout a specified time frame and/or decreasing the time spend on completing redundant information in the forms (e.g., name, address, parental information, allergies, etc.).

An advantage to the access aspect of the technology is that information is efficiently kept confidential and secure thereby ensuring that only users with authorization to access information can access the information (e.g., read, write, edit, e-sign, etc.). Another advantage to the technology the increased efficiency for users of the technology via the automated data and form collection which saves time and paper for the users of the technology (e.g., reduce clerical and information technology costs, reduce data entry by over 65%, reduce clerical tasks by over 20%, reduce transcription errors by over 80%, etc,).

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 illustrates an exemplary system for information and form access control;

FIG. 2A illustrates an exemplary communication device;

FIG. 2B illustrates an exemplary information and form access server;

FIGS. 3A-3T illustrate screen shots of exemplary user interfaces;

FIGS. 4A-4B illustrate exemplary access control tables,

FIGS. 5A-5B illustrate exemplary access control parameters;

FIGS. 6A-6H illustrate screen shots of exemplary user interfaces;

FIGS. 7A-7D illustrate screen shots of exemplary user interfaces;

FIG. 8 illustrates an exemplary flow chart for an information request;

FIG. 9 illustrates another exemplary flow chart for an information request;

FIG. 10 illustrates another exemplary flow chart for an information request; and

FIG. 11 illustrates an exemplary flow chart for access control.

### DETAILED DESCRIPTION

As a general overview of the technology, a plurality of users (e.g., a school administrator, a parent, a teacher, etc.) utilize communication devices (e.g., computer, personal digital assistant, etc.) to communicate with an information and form access server. The information and form access server provides secure access to information received from one or more of the plurality of users and/or requests additional information from one or more of the plurality of users. The information and form access server provides secure access by utilizing access control parameters associated with the information stored on the information and form access server (e.g., read/write for user group teacher, read only for user group student, read/write for user jsmith, etc.)

For example, a school administrator inputs information regarding a school field trip into the school computer, and the school computer communicates the information to the information and form access server. The information includes a list of students that want to attend the school field trip, a description of the school field trip, and a parent approval requirement. The information and form access server determines if additional information is needed for the school field trip (e.g., what additional information, if any, is needed to complete the form parameters associated with a field trip information form). In this example, the information and form access server determines that a parent approval is required for each student for the field trip. Based on this determination, the information and form access server generates a request for the additional information (in this example, parent approval) based on the information regarding the school field trip and an access control parameter associated with the information (e.g., parent/guardian that has access to approve a field trip for each student, write access for the school field trip approval parameter, etc.). The information and form access server transmits the request for the additional information (e.g., an email with a link to a website to input the additional information, a text message with a message that additional information is needed, etc.) to the respective parent for each student. The information and form access server can advantageously reduce the workload for information requests of an organization (e.g., a school, a doctor's office, a company, etc.) by automating the information requests and receipt of the information requests thereby increasing the efficiency of the organization via this automation.

As a further example, a parent receives the request for the additional information. The parent transmits an authentication request via a communication device to the information and form access server (e.g., the parent logs into a secure website provided by the information and form access server, email message from parent includes an e-signature, etc.). The information and form access server receives a response to the request for additional information from the parent via the communication device (e.g., the response is part of the authentication request, the response is an e-signature in a web form on the secure website, etc.). The information and form access server determines if the response is a complete response to the request (e.g., is the response to the request the e-signature, is other information needed based on the response to the request, etc.). If the response to the response is not complete, the information and form access server generates an additional request for information and transmits the additional request to the parent and or other user.

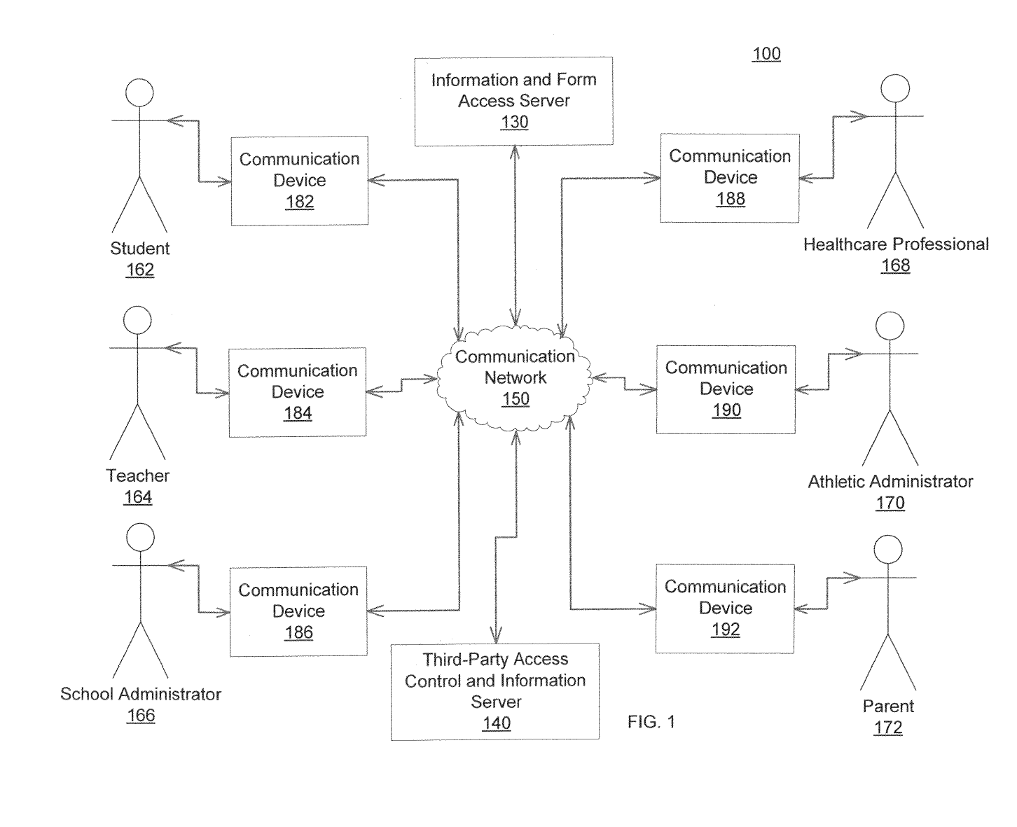

FIG. 1 illustrates an exemplary system 100 for information and form access control. The system 100 includes an information and form access server 130, a third party access control and information server 140, a communication network 150, a communication device 182, a communication device 184, a communication device 186, a communication device 188, a communication device 190, and a communication device 192 (the communication devices are hereinafter referred to as “communication device”). The system 100 is further utilized by a student 162, a teacher 164, a school administrator 166, a healthcare professional 168, and an athletic administrator 170, and a parent 172 (hereinafter referred to as “users”). The users utilize the communication devices to communicate with the information and form access server 130 and/or the third party access control and information server 140 via the communication network 150.

The information and form access server 130 receives information (e.g., student information, athletic information, health information, admissions information, etc.) from a user. The user communicates the information to the information and form access server 130 utilizing a communication device (e.g., a cell phone, a desktop personal computer, etc.). The information and form access server 130 determines if additional information is needed to complete an information form based on the information and/or a form parameter associated with the information form (e.g., parent approval is a form parameter associated with a field trip information form, doctor immunization record is a form parameter associated with a student health care form, dorm room preferences is a form parameter associated with a student housing form, etc.),

The information and form access server 130 generates a request to another user based on the determination of the additional information and an access control parameter associated with the additional information. For example, dorm room preferences is the additional information, and the access control parameter associated with the dorm room preferences is that the student is the only user that can write the dorm room preference. In this example, the information and form access server 130 generates the request to the student for a dorm room preference based on the determination that the dorm room preference is needed to complete the student housing form (e.g., mandatory form parameter, requested form parameter, etc.) and the access control parameter for the additional information that the student is the only user that can write the dorm room preference.

The information and form access server 130 transmits the request to the other user. For example, the information and form access server 130 transmits an email message to the student asking the user to reply to the email message with a list of preferred dorms. Upon receipt of the return email from the student, the information and form access server 130 authenticates the student (e.g., verifies the student's email address, verifies a passcode in the email message, etc.) and/or stores the additional information (e.g., the list of preferred dorms).

The information and form access server 130 can receive a transmission request for requested information from a different user (e.g., request from parent for student grade information, request from athletic administrator for weight and height information for all students, etc.). The information and form access server 130 authenticates that the different user has access to the requested information based an access control parameter associated with the requested information (e.g., authenticates the parent and verifies that the parent has read access to the student grade information, authenticates the athletic administrator and verifies that the athletic administrator has read access to the weight and height information for all students, etc.). The information and form access server 130 transmits the requested information to the different user based on the transmission request and the access control parameters associated with the requested information.

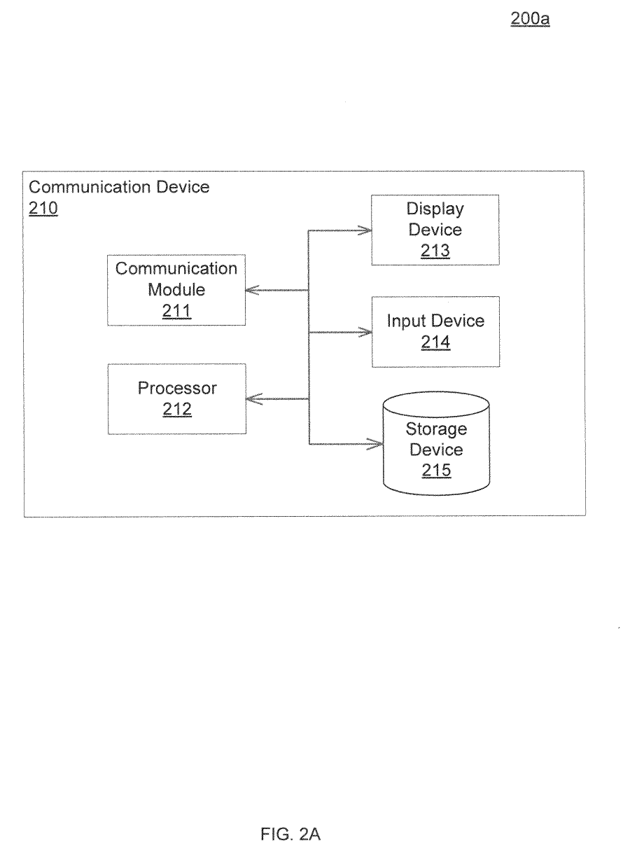

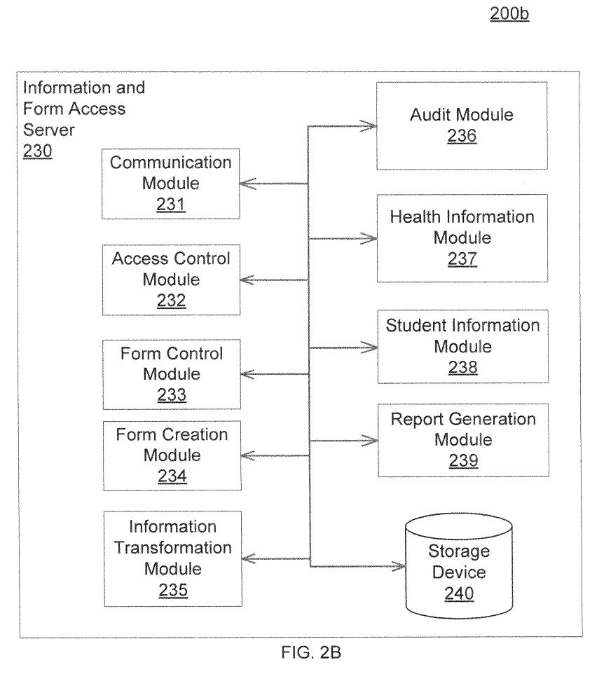

FIG. 2A illustrates an exemplary communication device 210 in a system 200a. The communication device 210 includes a communication module 211, a processor 212, a display device 213, an input device 214, and a storage device 215. The user (e.g., the student 162, the teacher 164, etc.) utilizes the communication device 210 to communicate with the information and form access server 130 of FIG. 1, the third-party access control and information server 140, and/or other communication devices. The communication module 211 communicates with the servers and/or devices via the communication network 150. The processor 212 processes communications, requests, responses, information, and or any other data associated with the communication device 210 (e.g., audio data, video data, etc.). The display device 213 displays communications, requests, responses, information, and/or any other data associated with the communication device 210. For example, the display device 213 displays the web page received from the information and form access server 130. The input device 214 provides for input into the communication device 210 (e.g., keyboard input, keypad input, voice command input, touch screen input, etc.). The storage device 215 stores communications, requests, responses, information, and/or any other data associated with the communication device 210. The storage device 215 can include any type of storage medium (e.g., random access memory, flash memory, hard-disk memory, etc.) and/or database.

FIG. 2B illustrates an exemplary information and form access server 230 on a system 200b. The information and form access server 230 includes a communication module 231, an access control module 232, a form control module 233, a form creation module 234, an information transformation module 235, an audit module 236, a health information module 237, a student information module 238, a report generation module 239, and a storage device 240.

The communication module 231 receives information from the user and/or transmits information to the user and/or a different user. The communication module 231 can transmit a request for additional information to another user. The communication module can transmit the information to a third user based on an access control parameter (e.g., access control parameter associated with the third user, access control parameter associated with the information, etc.) and/or a transmission request from the third user (e.g., request for student health information, request for teacher schedule, etc.). The communication module 231 can transmit the second request for the additional information to the other user based on the determination if the other user completed the request for the additional information. The communication module 231 can further communicate with other servers (e.g., the third-party access control and information server 140, a database server, etc.) and/or a plurality of communication devices. For example, the communication module 231 can receive an authentication request from the user and/or a response to a request from the user. As another example, the communication module 231 can transmit a report to the user requesting the report.

The access control module 232 determines the access control parameter associated with the information (e.g., information received from a user, additional information received in response to a request, etc.) based on one or more user types (e.g., student, teacher, etc.) associated with one or more users. The one or more user types can include a student, a parent, a teacher, an athletic administrator, a school administrator, a healthcare professional, and or any other type of user. For example, the access control module 232 determines that all field trip information is read-only for students, all field trip information is read/write for teachers, and for parents, the description of the field trip is read-only and the e-signature is read/write. As a further example, the access control module 232 determines that a first part of the student information, i.e., names, is read-only for teachers and a second part of the student information, i.e., grades, is read/write for teachers. In this example, the access control module 232 further determines that the first part of the student information, i.e., names, is read/write for school administrators and the second part of the student information, i.e., grades, is read only for school administrators.

The access control module 232 can authenticate a user based on the authentication request. For example, the access control module 232 can authenticate that the user has authorization to access information and/or authorization to write information based on a login and password received from the user. The authentication request can include an authorization from the third-party access control and information server 140 of FIG. 1 (e.g., a third-party content server for the organization that manages the user accounts, a network access server (NAS), a remote authentication dial in user service (RADIUS) server, a Kerberos server, etc.). For example, the user can send a login and password to the third-party access control and information server 140, and the third-party access control and information server 140 authenticates the user based on the login and password. In this example, the third-party access control and information server 140 transmits a credential authentication (i.e., authorization ok for the user) to the information and form access server 130.

The access control module 232 can generate a default access control parameter based on an access control template associated with one or more user types of one or more users. The access control module 232 can modify the default access control parameter based on an access request from the user (e.g., access request from school administrator that all teachers can read all student information, access request from parent that student can write student information, etc.). The access control module 232 can generate the access control parameter associated with the information based on the modified default access control parameter. Table 1 illustrates exemplary access control parameters for form parameters. The default access control parameters are generated by the access control module 232 based on an access control template for the form parameters and/or based on the user types (in this example, student, parent, and school administrator).

TABLE 1
Exemplary Access Control Parameters

| Form | Default Access Control | Modified Access | Access Control |
|---|---|---|---|
| Parameters | Parameter | Control Parameter | Parameter |
| Emergency | A. Student - Read Only | A. Student - | A. Student - Read/Write |
| Information | B. Parent - Read/Write | Read/Write | B. Parent - Read/Write |
| | C. School Administrator - | | C. School Administrator - |
| | Read/Write/Request | | Read/Write/Request |
| Parent | A. Student - Read Only | None | A. Student - Read Only |
| Permission | B. Parent - Read/Write | | B. Parent - Read/Write |
| | C. School Administrator - | | C. School Administrator - |
| | Read/Request | | Read/Request |
| Athletic | A. Student - Read Only | A. Student - | A. Student - |
| Permission | B. Parent - Read/Write | Read/Request | Read/Request |
| | C. School Administrator - | | B. Parent - Read/Write |
| | Read/Request | | C. School Administrator - |
| | | | Read/Request |

The form control module 233 determines if the additional information is needed to complete an information form based on the information and a form parameter associated with the information form. The form control module 233 generates the request for additional information to the other user based on the determination of the additional information and a second access control parameter associated with the other user.

The form creation module 234 selects the information form from one or more predetermined information forms (e.g., field trip information form, athletic information form, emergency information form, etc.) based on the information and a user type associated with the user. The predetermined information forms can include, for example, a parent form (e.g., dismissal authorization form, field trip form, etc.), a student form (e.g., class selection form, student agreement form, etc.), an athletics form (e.g., athletics user fee form, parent permission form, etc.), a health form (e.g., medication permission form, health form, etc.), and/or any other type of information for.

For example, the school nurse transmits information regarding the school physical information requirements (in this example, the school nurse provides information that the physical information is required yearly). Based on the school physical information, the form creation module 234 selects a physical information form from the one or more predetermined information forms based on the received information (in this example, the school nurse's information that the physical information form needs to be completed by the student's physician) and based on the user type associated with the school nurse (in this example, the school nurse is a healthcare professional requesting the physical information for a student which is directed to the student's physician, i.e., another healthcare professional).

The information transformation module 235 transforms information between data types, data protocols, and/or information forms. For example, the information transformation module 235 populates standard information across the plurality of information forms (e.g., student information and parent contact information in all information forms associated with a student, athletic information in all information forms associated with athletics, etc.). As another example, the information transformation module 235 transforms information for communication with a third-party server (e.g., the third-party access control and information server 140, a database server, etc.). As another example, the information transformation module 235 transforms information for communication with other school system servers (e.g., transformation from an internet protocol to an internetwork packet exchange protocol, encapsulation of information for communication via a different network technology, i.e. virtual private network, etc.).

The audit module 236 audits the information, the requests, the responses, and/or any other communication to and from the information and form access server 230. For example, the audit module 236 verifies the authentication of each user to ensure that the user has authorization to access (e.g., read, write, request, etc.) information. The audit module 236 can further log the requests, the responses, and/or any other communication. The logged information can be utilized to audit the system 200b for security purposes (e.g., confidentiality, integrity, availability, etc.).

The health information module 237 determines if the response to the request for health information from a healthcare professional is complete. The health information module 237 can further track and/or request other types of healthcare information (e.g., illness, diagnosis, prescription, health form, allergies, etc.).

The student information module 238 determines if the response to the request for the additional information from the other user is complete. For example, if the request for the additional information is for a health professional's physical examination information form, the student information module 238 determines if the response from the health professional (e.g., doctor, nurse, etc.) is complete. In other words, the student information module 238 determines if the form parameters for the physical examination information form were completed by the health professional (e.g., all of the mandatory form parameters are complete, all of the form parameters are complete, etc.).

Table 2 illustrates an exemplary physical examination information form with the form parameters. As illustrated in Table 2, all of the form parameters are complete. In this regard, the student information module 238 determines that the response to the request for the additional information from the other user is complete (i.e., the healthcare professional's response for the vaccines, physical exam, lung capacity test, and one mile walk test is complete), Table 3 illustrates an exemplary athletic information form that embeds the physical examination information form. As illustrated in Table 3, the parent permission form parameter and the teacher permission form parameter are incomplete. The student information module 238 determines that the response to the request for the additional information is not complete. The student information module 238 can generate a second request for the additional information based on this determination. For example, the second request for the additional information is directed to the parent of the student for the parental permission. As another example, the second request for the additional information is directed to the teacher(s) of the student for teacher permission. In this example, the student information module 238 can generate requests for the parent and/or the teacher(s).

TABLE 2
Exemplary Physical Examination Information Form

| | Student | Athlete | |
|---|---|---|---|
| Form Parameters | Requirement | Requirement | Status |
| Vaccines | Required | Required | Complete |
| Physical exam | Required | Required | Complete |
| Lung capacity test | Optional | Required | Complete |
| One mile walk test | Optional | Required | Complete |

TABLE 3
Exemplary Athletic Information Form

| Form Parameters | Requirement | Status |
|---|---|---|
| Physical Examination Information Form - | Required | Complete |
| Athlete Requirements | | |
| Emergency Information | Required | Complete |
| Parent Permission | Required | Incomplete |
| Athletic Administrator Permission | Required | Complete |
| Teacher Permission | Optional | Incomplete |

The report generation module 239 generate a report based on the information, a report request from a user, and/or an access control parameter associated with the information. For example, the report generation module 239 generates a report of student information based on a report request from a school administrator. In this example, the access control parameter associated with the student information allows the school administrator read access to the student information.

The storage device 240 can store, organize, and/or retrieve information, responses, requests, access control parameters, forms, and/or any other data associated with the information and form access server 130. The storage device 240 can include any type of storage medium (e.g., random access memory, flash memory, hard-disk memory, etc.) and/or database.

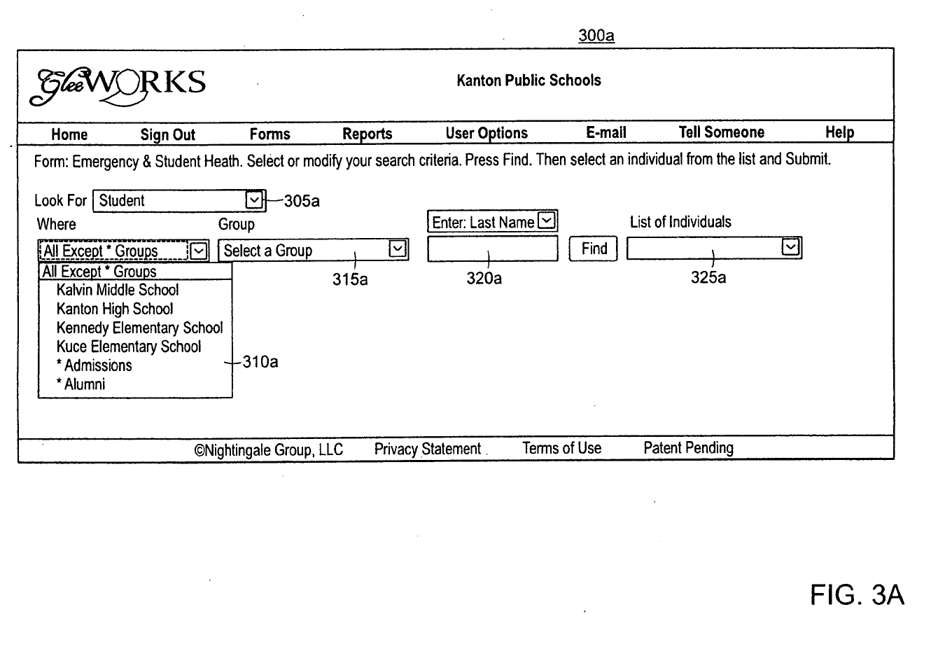

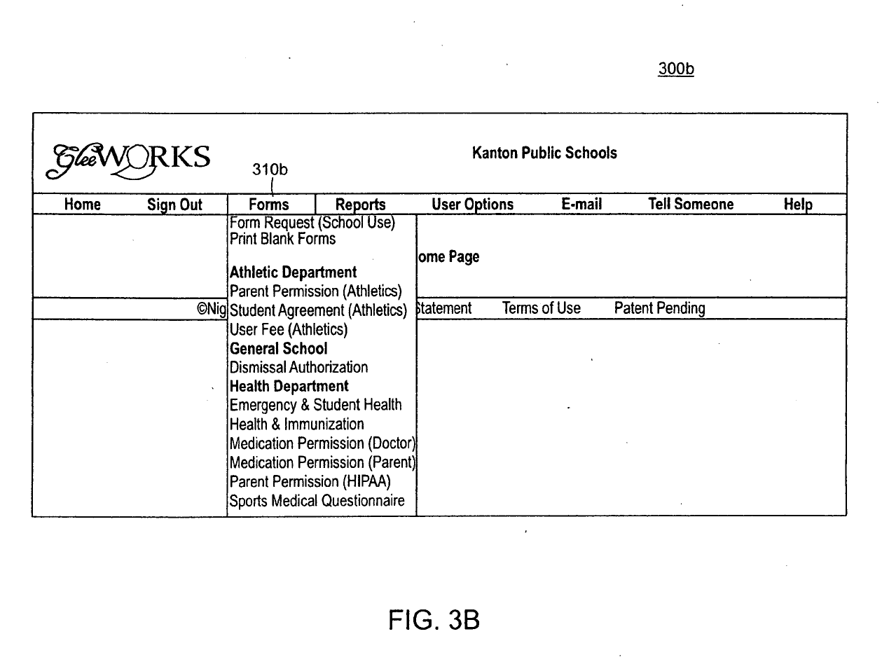

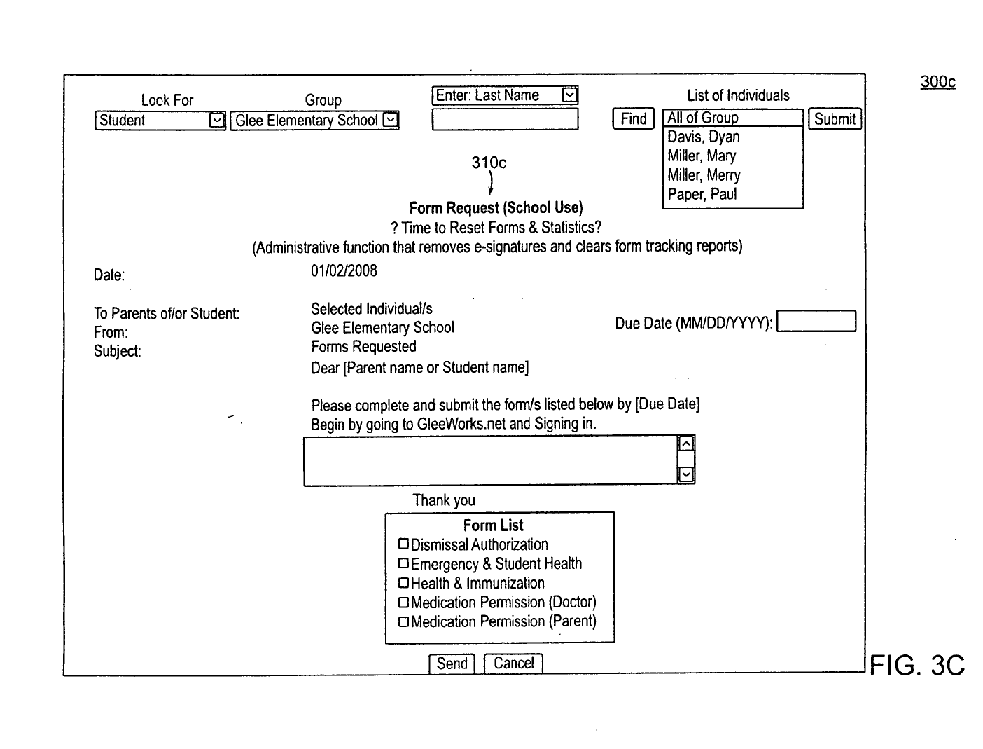

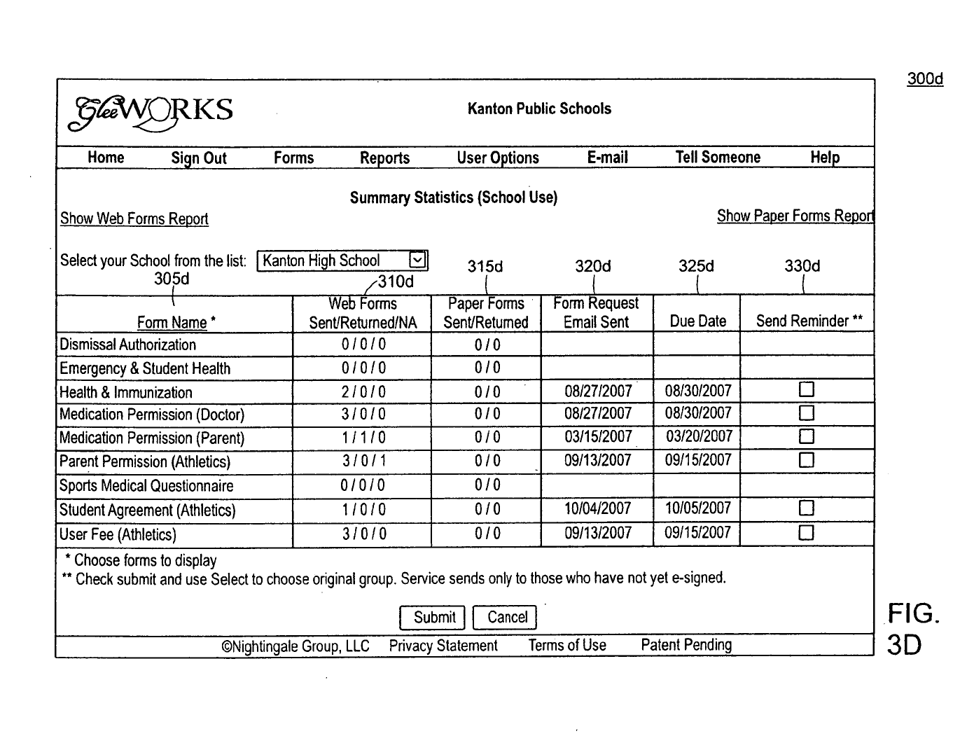

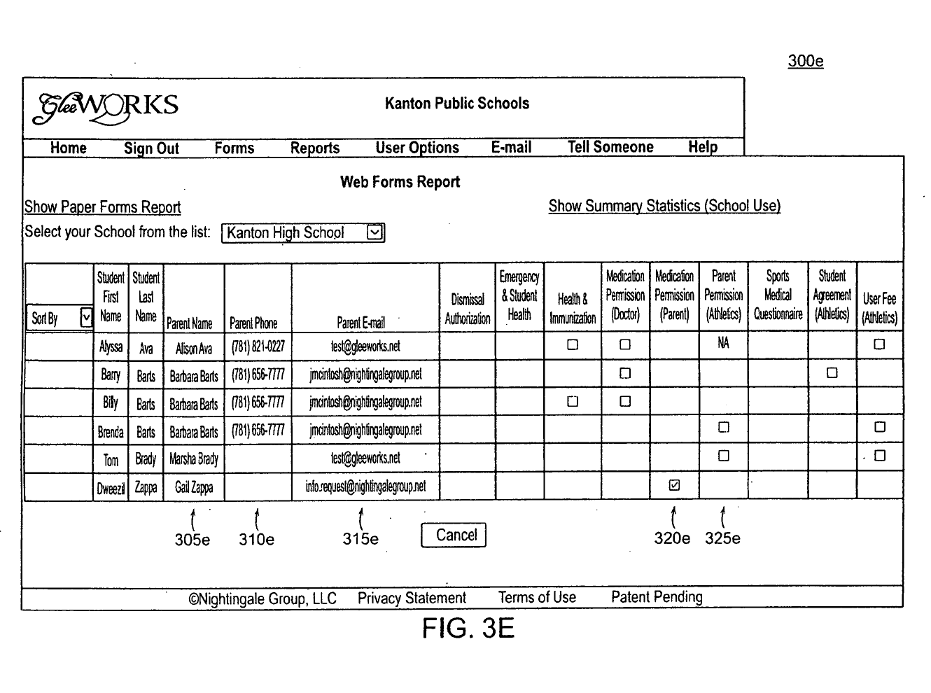

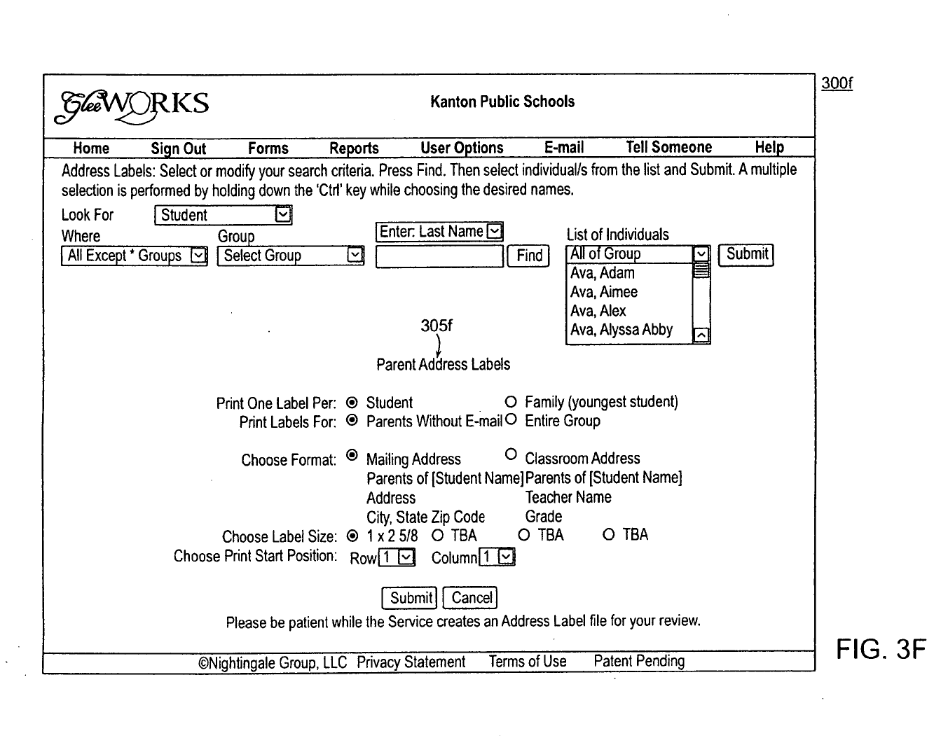

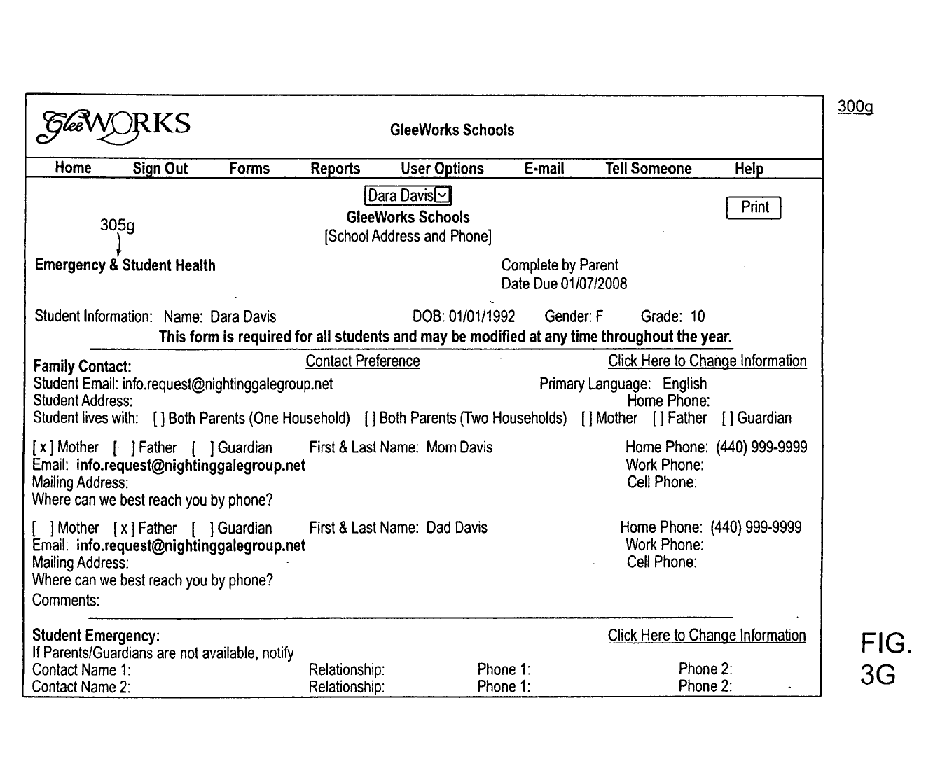

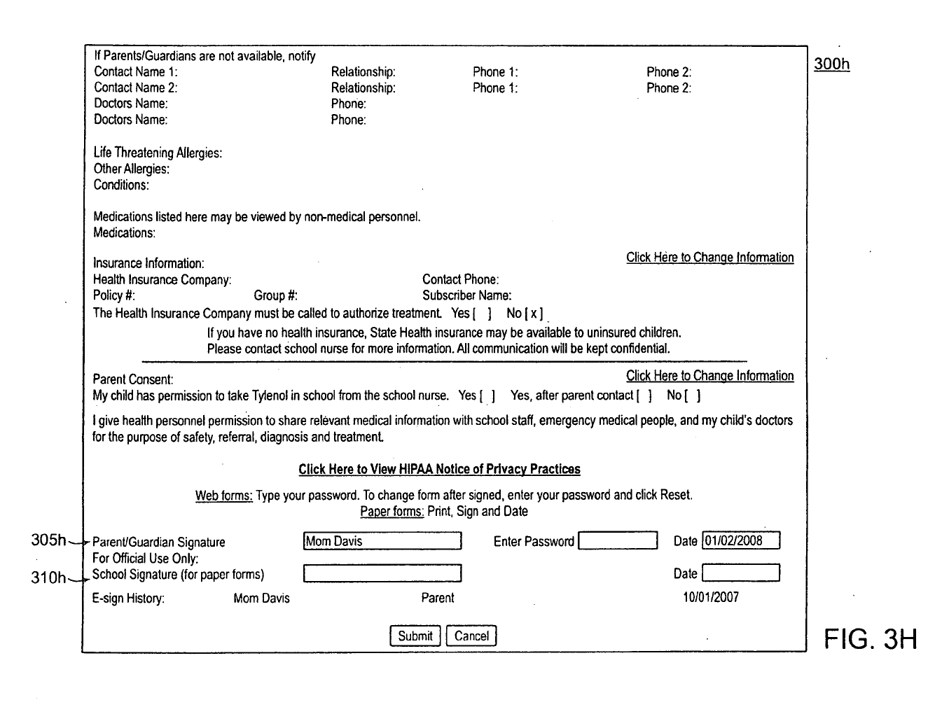

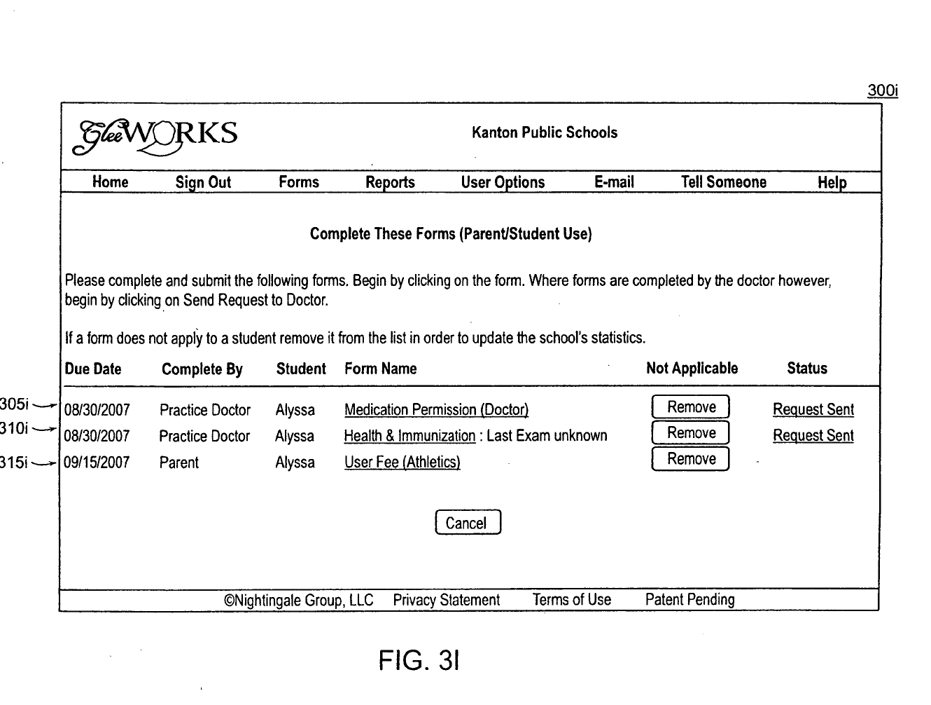

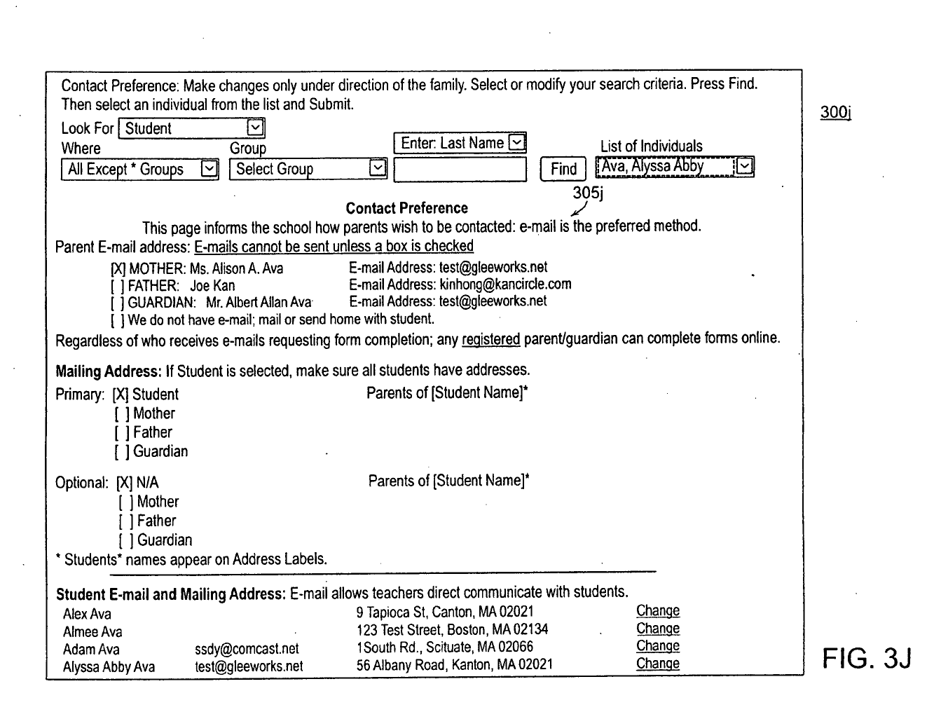

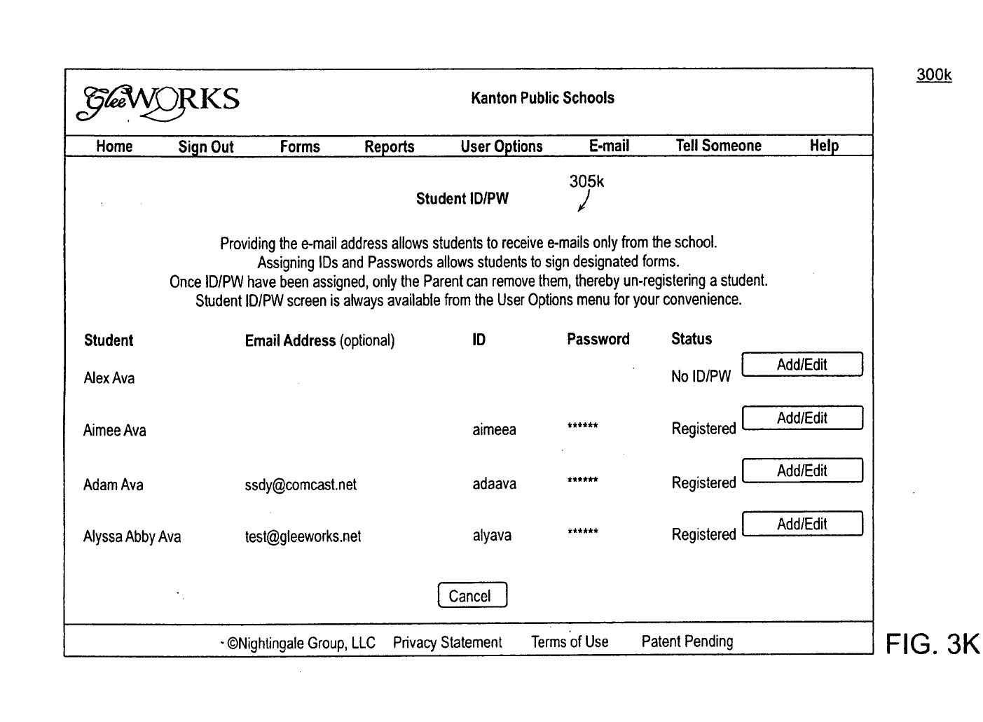

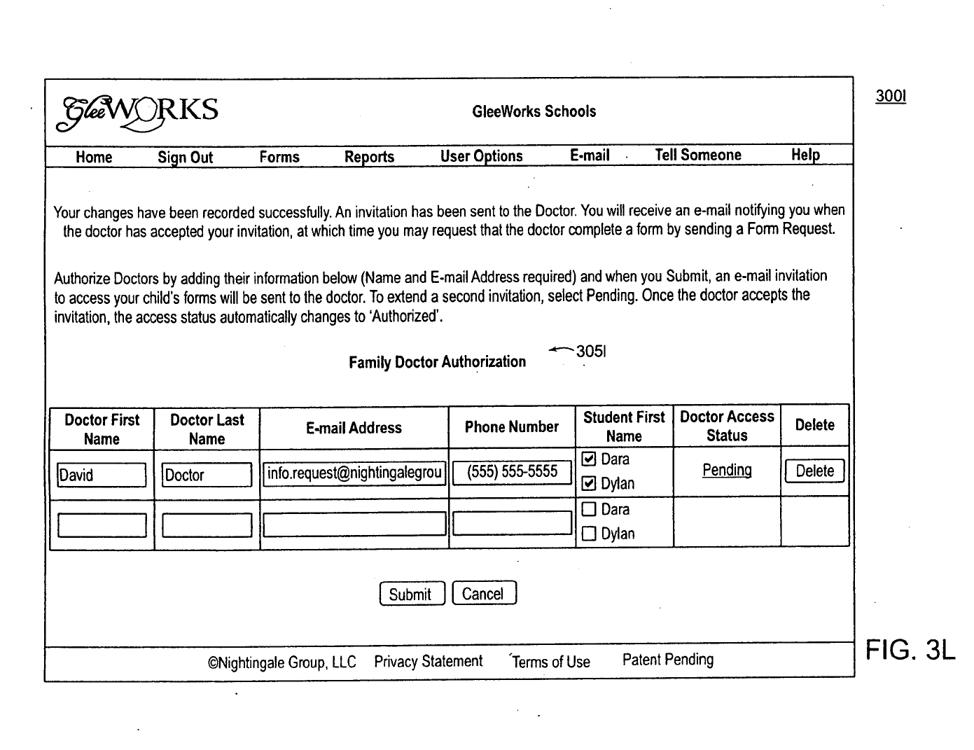

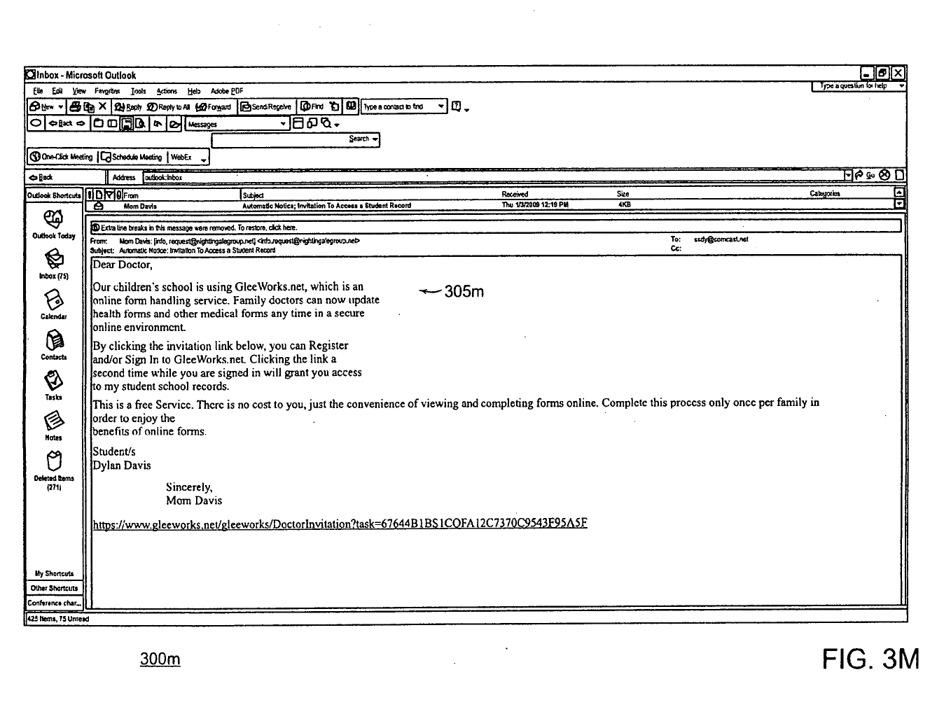

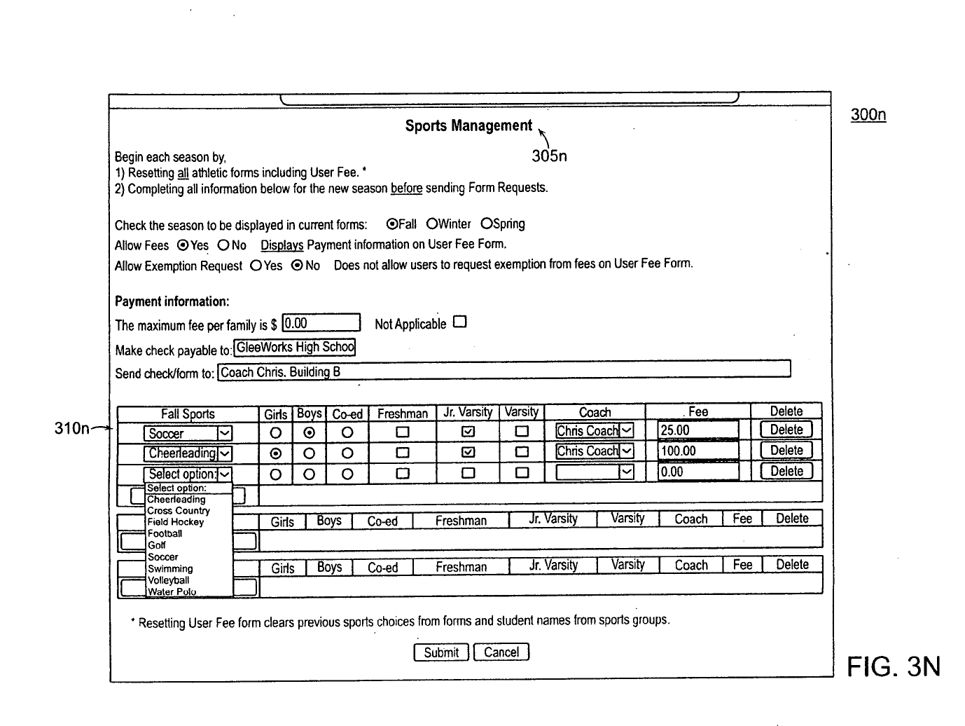

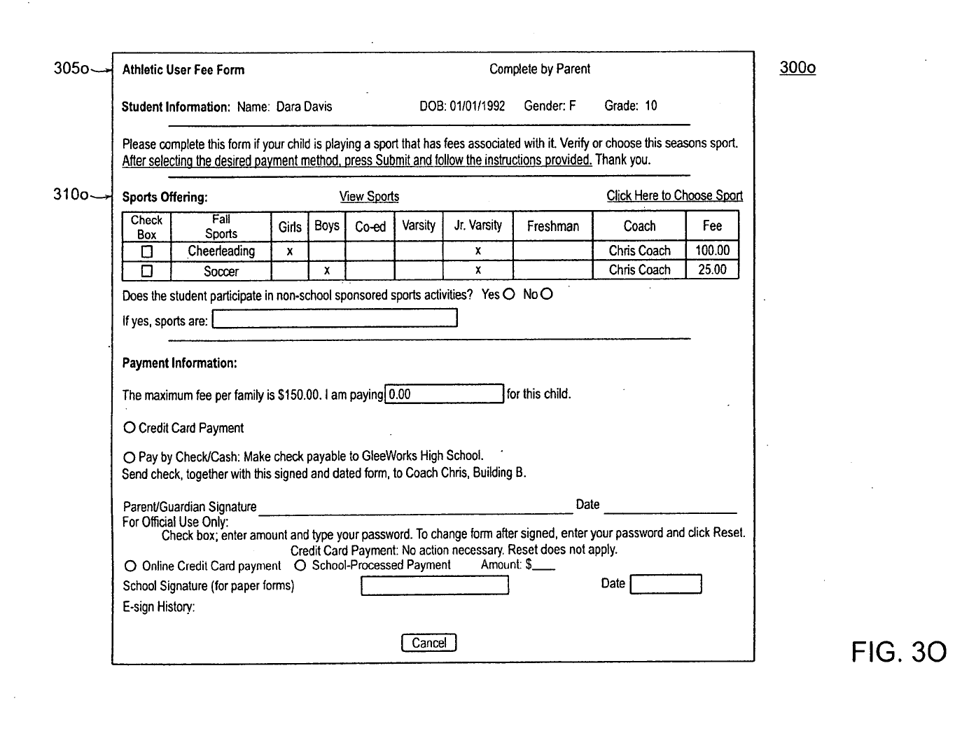

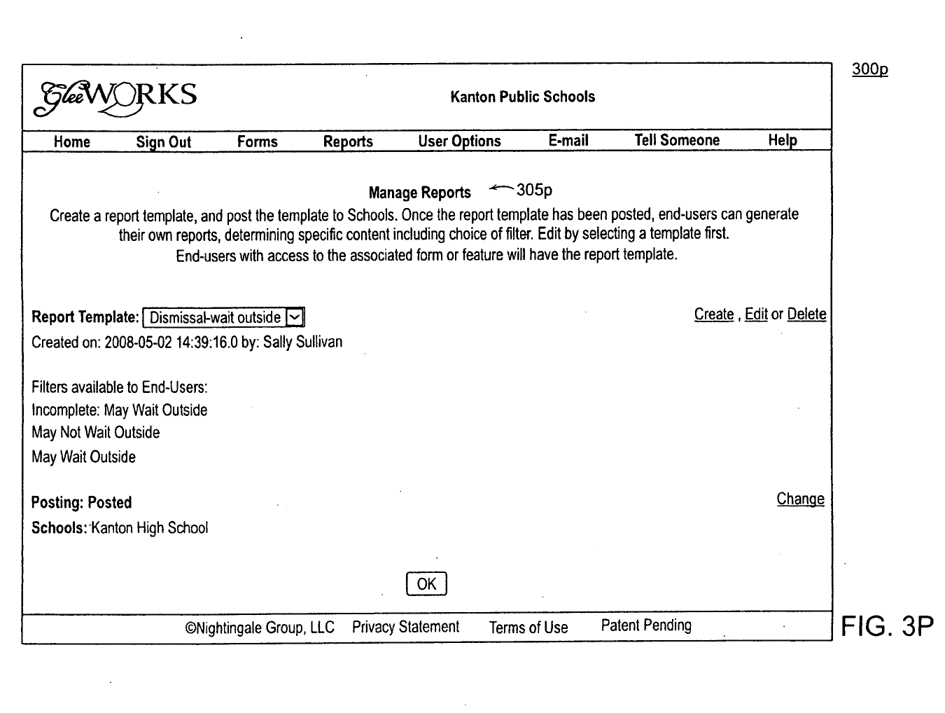

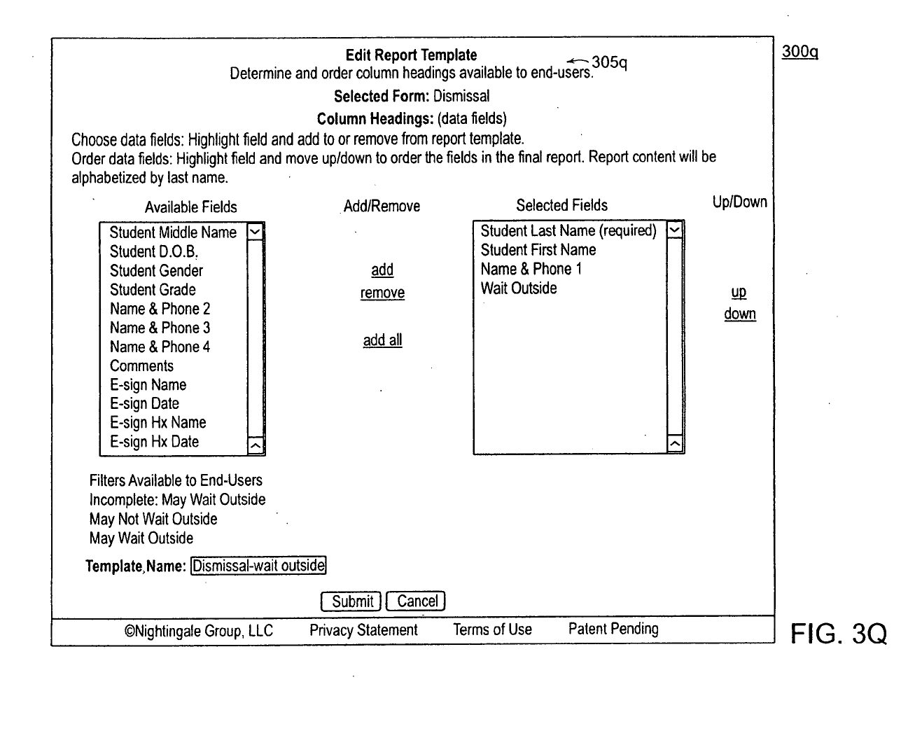

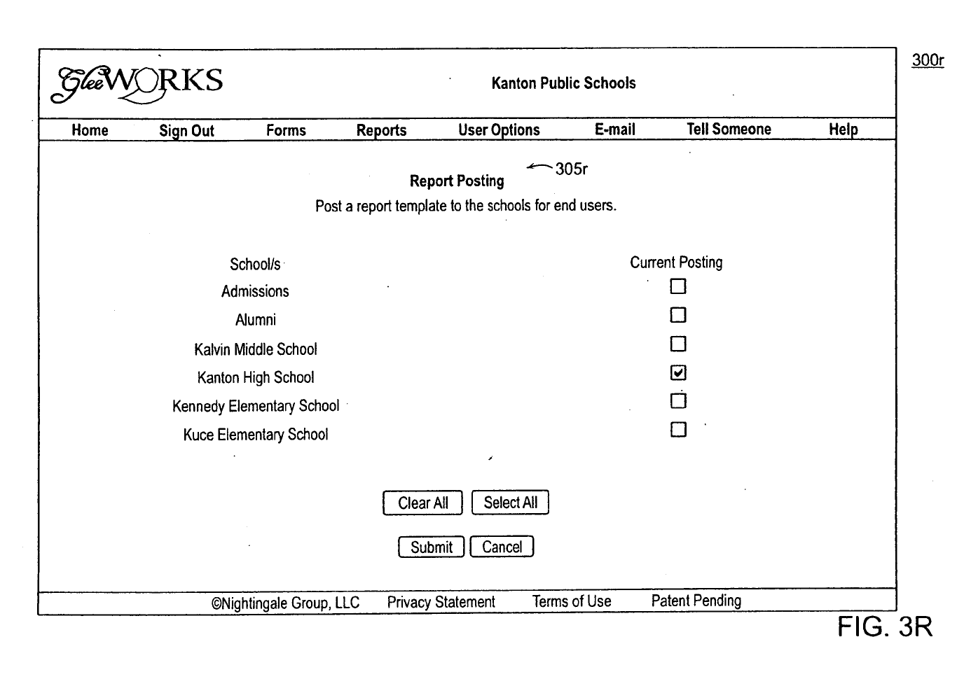

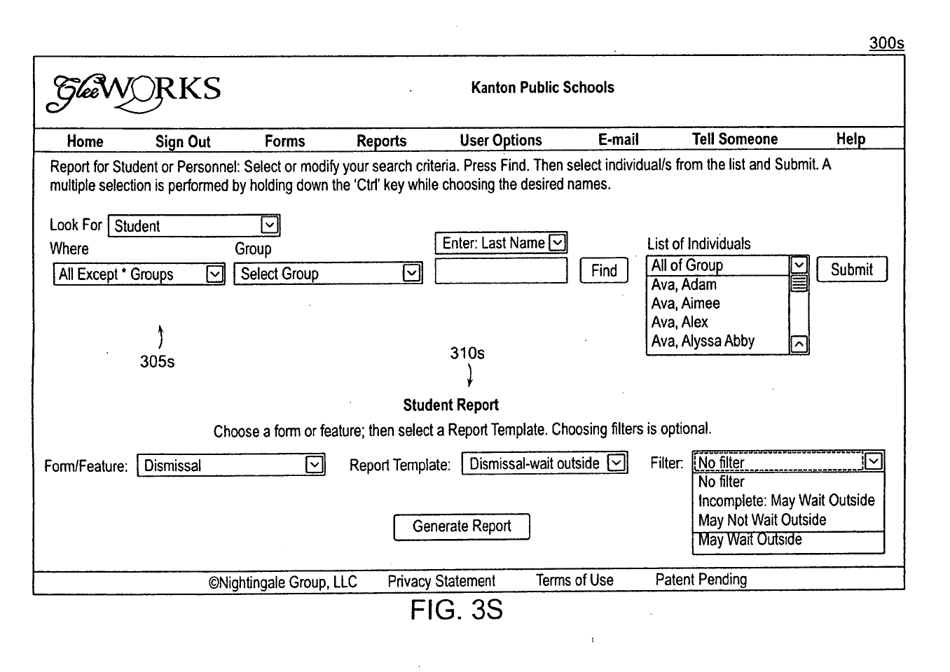

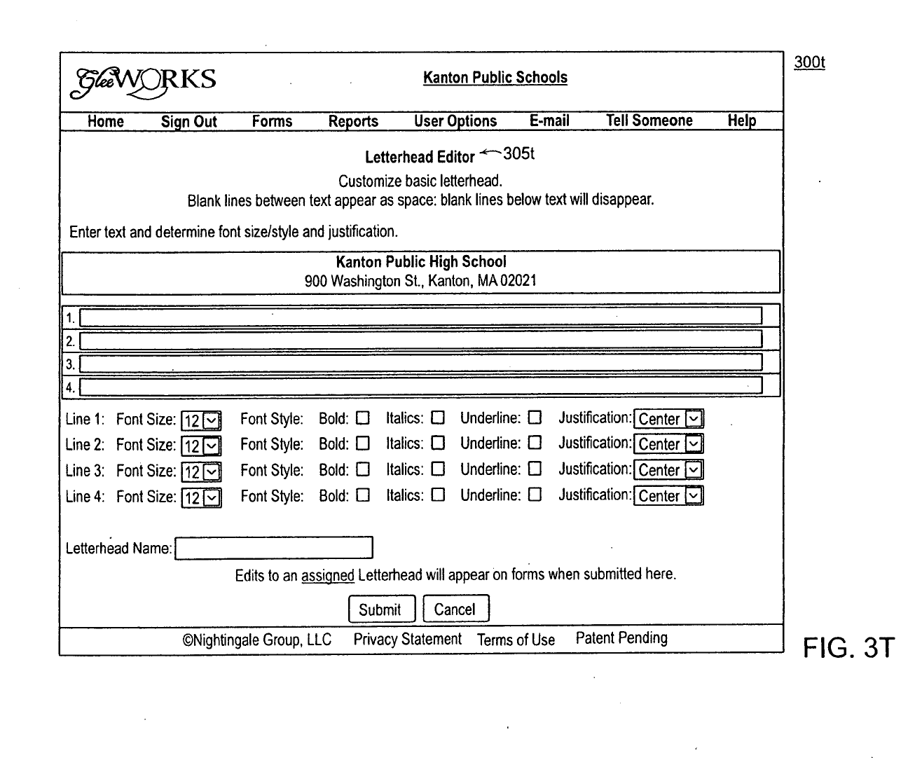

FIG. 3A illustrates an exemplary screen shot of a user interface 300a to search a form. The user interface 300a includes a different user lookup 305a, a group lookup 310a, a select group lookup 315a, a search field 320a, and a list of individuals lookup 325a. The search features enable a user to search an emergency and student health form via the user interface 300a.

FIG. 3B illustrates an exemplary screen shot of a user interface 300b for form selection. The user interface 300b includes a forms field 310b. The forms field 310b is utilized by a user to select a new form for one or more other users to complete (e.g., the information includes the form request from the user).

FIG. 3C illustrates an exemplary screen shot of a user interface 300c for a form request. The user interface 300c includes a forms request 310c for school use. The user selects the “Form Request (School Use)” as illustrated in the user interface 300b of FIG. 3B, and the form control module 234 of FIG. 2B generates the user interface 300c to allow the user to select the forms for completion by other users.

For example, the user (in this example, the school administrator) selects the dismissal authorization form from the form list and selects the parents of all first grade students as the selected individuals. Based on this information from the user, the form control module 233 determines that additional information is needed to complete the dismissal authorization form. The additional information includes where the student can be dismissed to (e.g., wait for parent pick-up, bus drop-off, etc.) and an e-signature from a parent. The form control module 233 generates a request for the additional information based on the determination and an access control parameter associated with the additional information (in this example, the access control parameter that the parent is the user that can write to the information form parameters). The communication module 231 transmits the request for the additional information to the parent (e.g., email to the parent requesting the additional information, automated postal mail to the parent requesting the additional information, etc.).

FIG. 3D illustrates an exemplary screen shot of a user interface 300d. The user interface 300d includes a form list 305d, a list of web forms sent/returned/NA 310d, a list of paper forms sent/returned 315d, a list of form request emails sent 320d, a due date column 325d, and a send reminder column 330d. The report generation module 239 can generate the summary statistics report illustrated in the user interface 300d based on a report request from the user. For example, the user can select “Reports,” “Summary Statistics,” and then select the appropriate school “Kanton High School,” if applicable. The summary statistics provide an overview of all of the forms utilized by the school along with other detailed information regarding the forms.

FIG. 3E illustrates an exemplary screen shot of a user interface 300e. The user interface 300e includes a list of the parent names 305e, a list of parent phone numbers 310e, a list of parent email addresses 315e, a parent medication permission field 320e, and a parent permission athletics field 325e. The user interface 300e further includes other permission fields (e.g., dismissal authorization, emergency & student health, etc.). The report generation module 239 can generate the report illustrate in the user interface 300e based on a report request from the user.

FIG. 3F illustrates an exemplary screen shot of a user interface 300f. The user interface 300f includes a parent address label printing field 305f and search functionality for the address label printing. The user can utilize the user interface 300f to request the parent address label report via the report generation module 239.

FIG. 3G illustrates an exemplary screen shot of a user interface 300g of a first part of an emergency and student health form 305g. As illustrated in the user interface 300g, the emergency and student health form 305g includes student information, family contact information, and student emergency information. The student information and family contact information can be requested from the parent and/or retrieved from the storage device 240 (e.g., stored in the storage device 240 from an earlier response for information, stored in the storage device 240 from input from the school administrator, etc.).

FIG. 3H illustrates an exemplary screen shot of a user interface 300h of a second part of the emergency and student health form 305g. The user interface 300h includes a parent/guardian signature block 305h and a school signature block 310h. The emergency and student health form 305g further includes life threatening allergies, medications, insurance information, and parent consent. As illustrated, the emergency and student health form 305g requires both the parent/guardian signature block 305h and the school signature block 310h. The parent/guardian can complete the requested information and ensign the form utilizing the parent/guardian signature block 305h and a password (in this example, the signature and password authenticate the parent). The user can utilize the emergency and student health form 305g to input information (e.g., family contact information, etc. student emergency information, etc.) and/or request additional information (e.g., parent e-signature, parent consent information, etc.).

FIG. 3I illustrates an exemplary screen shot of a user interface 300i utilized to complete information forms. The user interface 300i includes a medication permission information form 305i, a health and immunization information form 310i, and a user fee information form 315i. As illustrated in the user interface 300i, the parent and/or the student can utilize the user interface 300i to request additional information from a practice doctor via the medication permission information form 315i. In this regard, the transmission of the request for additional information to the other user by the communication module 231 can be controlled by the user. In other examples, the communication module 231 automatically transmits the request for additional information to the other user after generation of the request by the form control module 233.

FIG. 3J illustrates an exemplary screen shot of a user interface 300j for searching for the preferred contact method for students. The user interface 300j includes a contact preference screen 305j. The user interface 300j further provides for searching of various fields to view the contact preferences for users. In this regard, the access control module 232 can determine if the user has access to the requested contact preferences information. For example, a teacher only has access to view the student contact preferences enrolled in the teacher's preferences and the school administrator can view all student contact preferences.

FIG. 3K illustrates an exemplary screen shot of a user interface 300k allowing the addition/edit of student information. The user interface 300k includes a student ID and password screen 305k. The student ID and password screen 305k allows a parent and/or a school administrator to add contact information and/or authentication information for students. The access control module 232 can utilize the authentication information to authenticate students for information and/or form access (e.g., read, write, signature, etc.). The form control module 233 can utilize the contact information to request additional information from the students (e g., contact information, e-signature, etc.). In other examples, the access control module 232 can request the addition/edit/deletion of the students as users on the third-party access control and information server 140 of FIG. 1.

FIG. 3L illustrates an exemplary screen shot of a user interface 300l for family doctor authorization. The user interface 300l includes a family doctor authorization 305l. The family doctor authorization 305l provides for the input of doctor contact information and associated students. In this regard, the form control module 233 can request additional information from the doctor utilizing the doctor contact information.

FIG. 3M illustrates an exemplary screen shot of a user interface 300m. The user interface 300m includes a request for additional information from a doctor 305m. The request 305m is in the form of an email message from the student's parent to the doctor. The request 305m includes information about the student and how to access a website to provide the requested additional information.

FIG. 3N illustrates an exemplary screen shot of a user interface 300n for sports management. The user interface 300n includes a sports management information form 305n and sports information 310n. The sports information 310n includes the fall sports, gender, level, coach, and user fee. The athletic administrator can utilize the sports management information form 305n to input information about students and the respective sports and request additional information (e.g., request parent permission, request user fee, request physical exam, etc.).

FIG. 3O illustrates an exemplary screen shot of a user interface 300o for an athletic user fee information form 305o. The athletic user fee form 305o includes a sports offering list 310o and other requested information (in this example, user fee payment). The parent can utilize the athletic user fee information form 305o to complete the request for additional information (in this example, confirmation of the sports offering list 310o, additional sports activities field, and athletic user fee payment fields).

FIG. 3P illustrates an exemplary screen shot of a user interface 300p for managing reports. The user interface 300p includes a manage reports information form 305p. The user can manage the plurality of reports utilizing the manage reports information form 305p (e.g., edit a report, delete a report, add a new report, etc.).

FIG. 3Q illustrates an exemplary screen shot of a user interface 300q for editing report templates. The user interface 300q includes a report editing template 305q. The report editing template 305q provides the user with an interface to add and/or remove available fields for a selected form (in this example, the dismissal information form).

FIG. 3R illustrates an exemplary screen shot of a user interface 300r for report posting 305r. The report posting 305r provides the user (e.g., the school administrator, the system administrator, etc.) with a plurality of reports to post for users at various schools. In this example, the selected report is posted to Kanton High School.

FIG. 3S illustrates an exemplary screen shot of a user interface 300s for generating a student report 310s. The user interface 300s includes search functions 305s which provide the user with search capabilities to access information. The student report 310s enables the user to select form/features with a report template and/or a filter to generate the report via the report generation module 239.

FIG. 3T illustrates an exemplary screen shot of a user interface 300t for editing a report The user interface 300t includes a letterhead editor 305t. The letterhead editor 305t provides the user with an interface to edit/add/delete information for a letter, a request, and/or a report associated with the selected school.

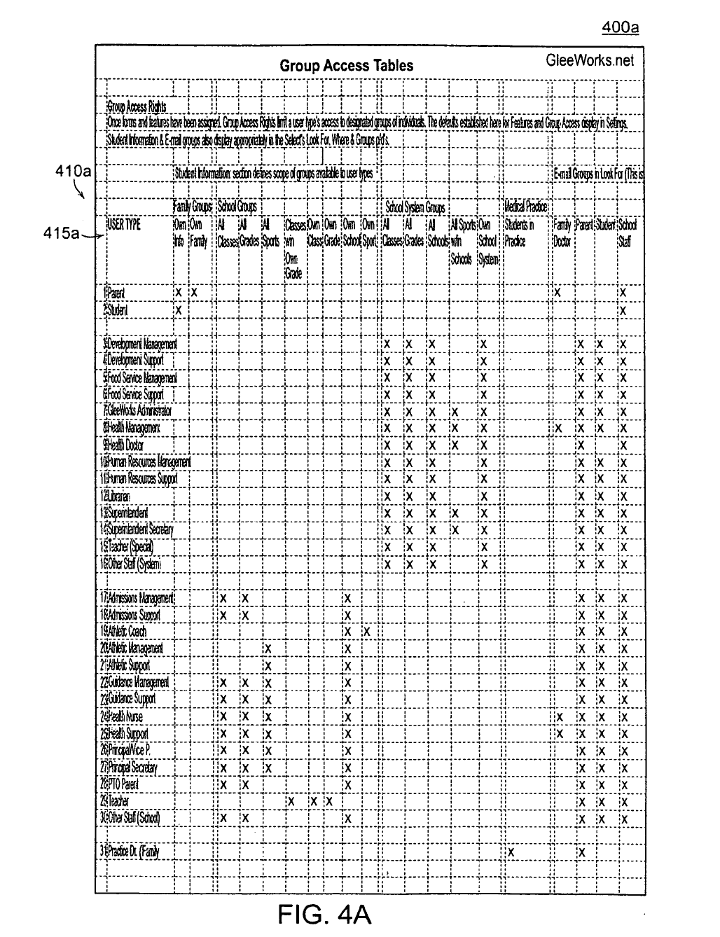

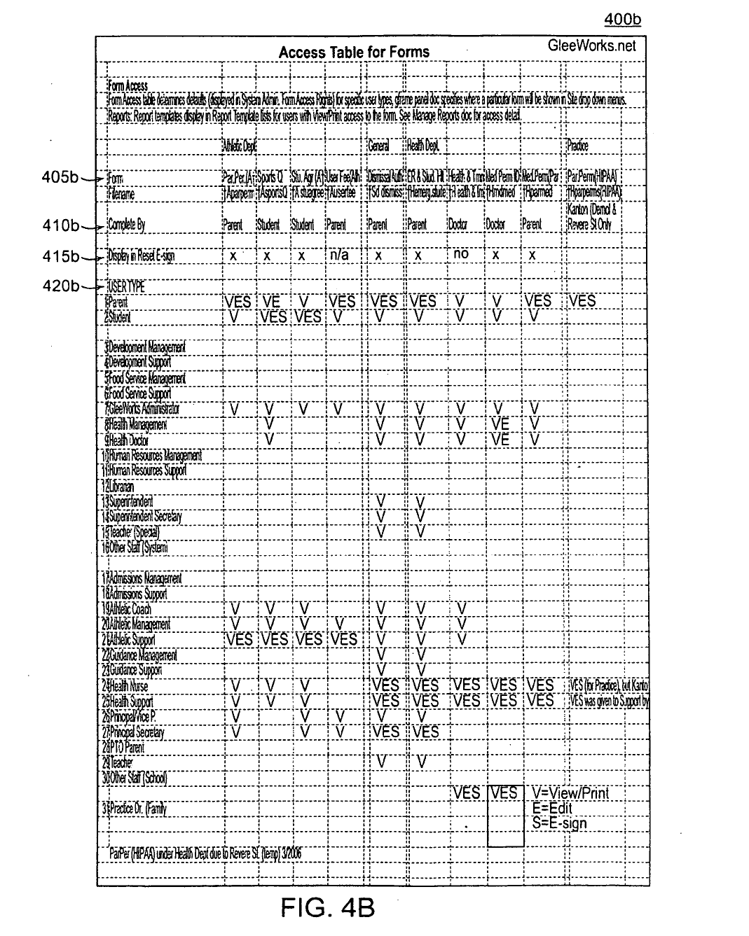

FIG. 4A illustrates an exemplary access field table 400a. The access field table 400a includes user groups 410a, user types 415a, and access control parameters. The user groups 410a includes family group, school group, school system group, and medical practice group. As illustrated in the access field table 400a, the users types 415a have access control parameters associated with each user based on the user group 410a.

The user types 415a include parent, student, development management, development support, food service management, food service support, system administrator, health management, health doctor, human resources management, human resources support, librarian, superintendent, superintendent secretary, special teacher, other staff, admissions management, admissions support, athletic coach, athletic management, athletic support, guidance management, guidance support, health nurse, health support, principal, vice principal, principal secretary, parent teacher organization (PTO) parent, teacher, other staff, and family practice doctor. Although the system 100 of FIG. 1 illustrates six users, the system 100 can utilize any number of users and/or the plurality of users can be classified via any number of user types (e.g., the six users illustrated in FIG. 1 are the user types, the user types 415a illustrated in FIG. 4A are the user types, etc.).

FIG. 4B illustrates an exemplary access field table for forms 400b. The access form field table 400b includes different forms 405b, information regarding the completion for the forms 410b, a e-signature information 415b, and various user types 420b. The access field table 400b provides access control parameters for the access control module 232 regarding the information forms (in this example, which user types have view/print, edit, and/or e-sign access to the information forms).

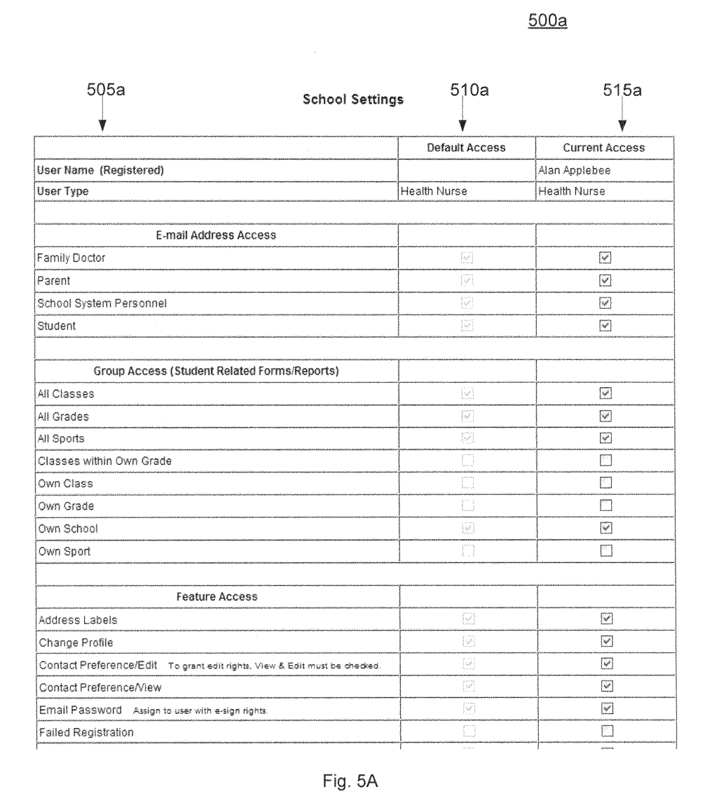

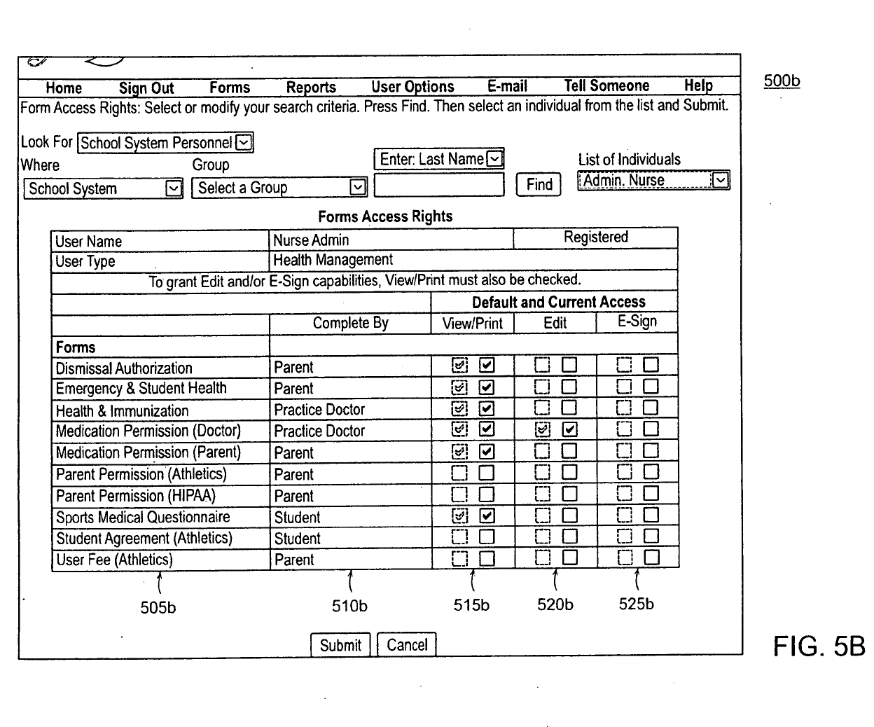

FIG. 5A illustrates exemplary access control parameters 500a. The access control parameters 500a include access type 505a, default access control parameters 510a, and current access control parameters 515a. The default access control parameters 510a can be generated by the access control module 232 based on an access control template associated with the user type of the user (in this example, the user is Alan Applebee and Alan's user type is Health Nurse). In other words, the user type Health Nurses by default, has access to the information and/or features as illustrated in FIG. 5A. A user (e.g., the system administrator, the school administrator, etc.) with authorized access can modify the default access control parameters 510a to generate the current access control parameters 515a.

FIG. 5B illustrates an exemplary screen shot of a user interface 600a for form access control. The user interface 600a includes various forms 505b, a complete by field for the forms 510b, access rights for view/print 515b, edit access rights 520b, and e-sign access rights 525b. The user can modify the access control parameters for the form via the user interface 600a.

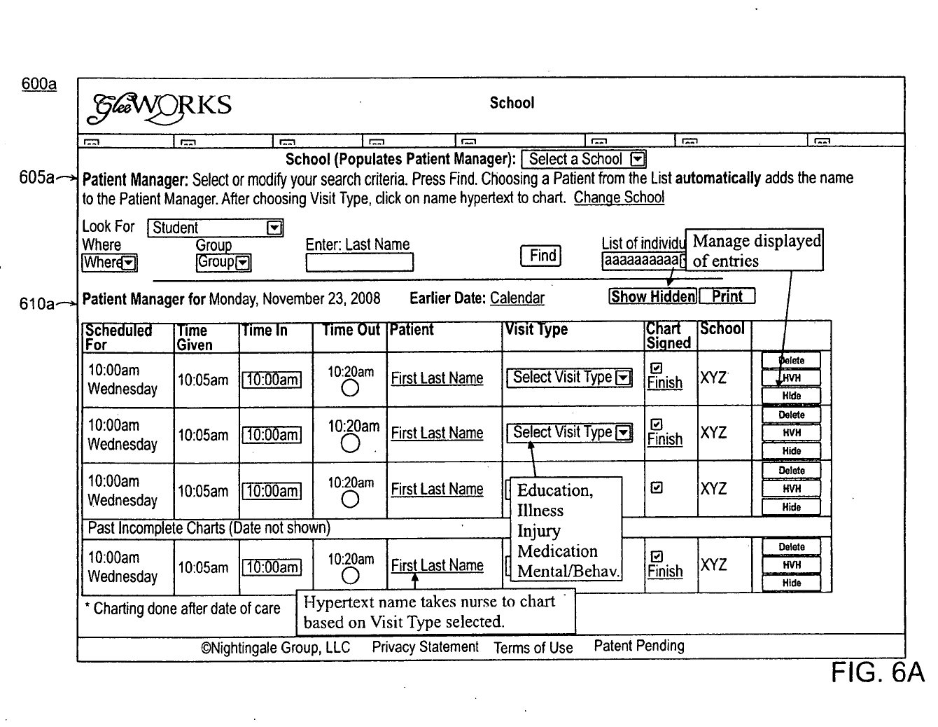

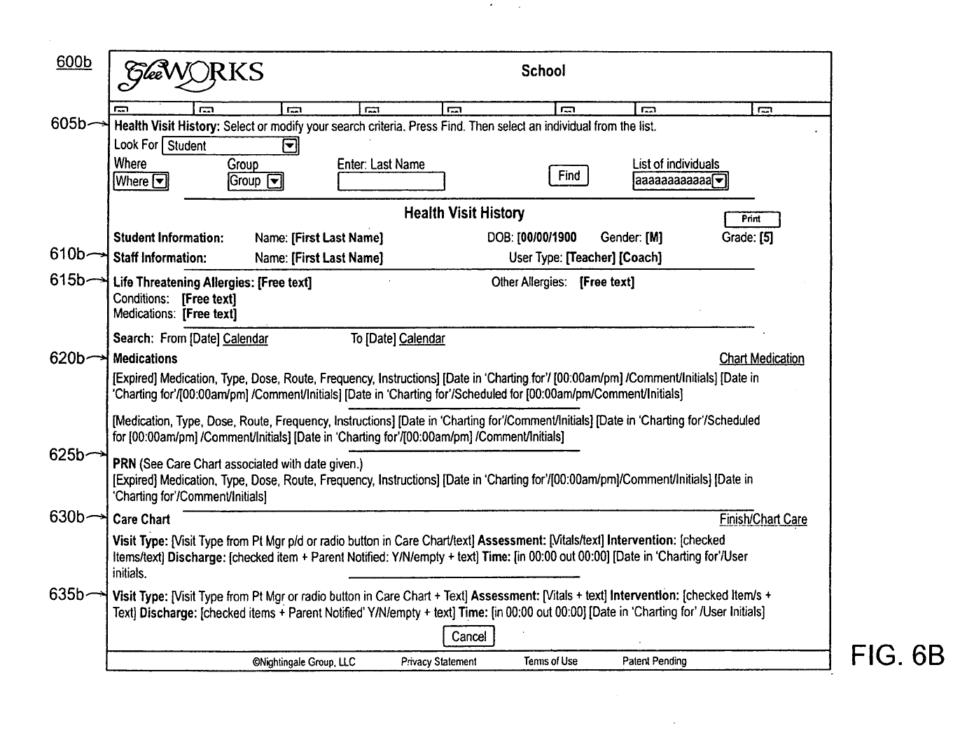

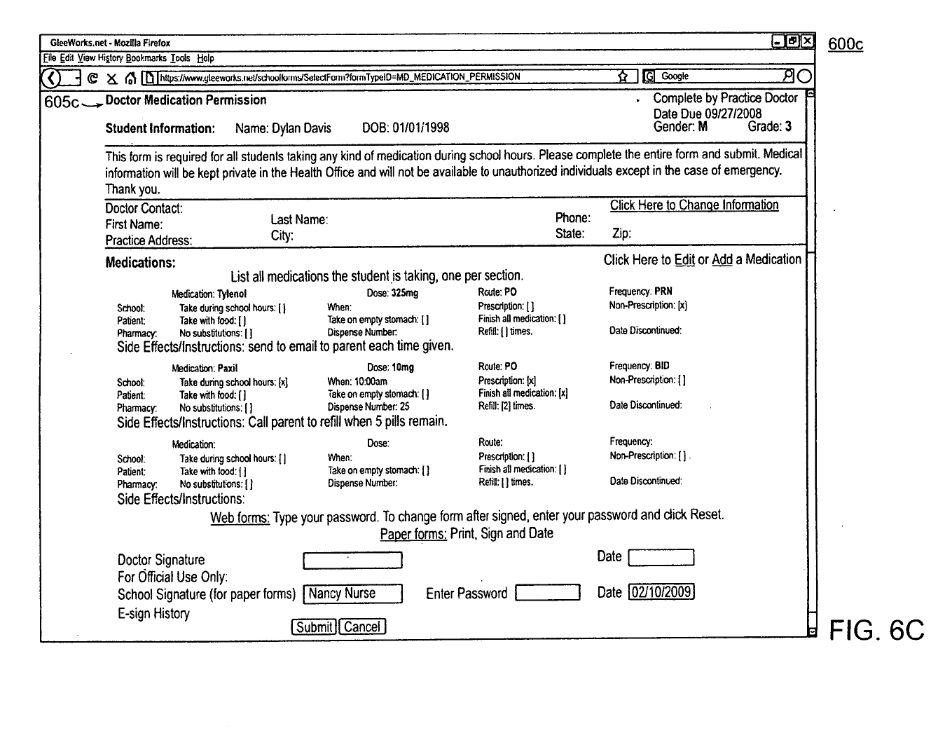

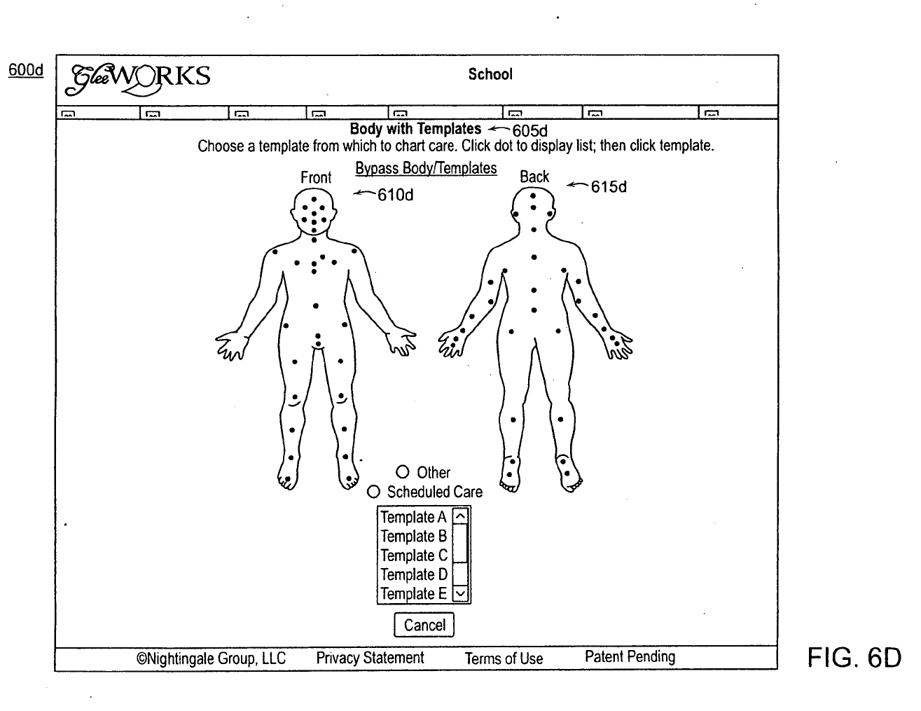

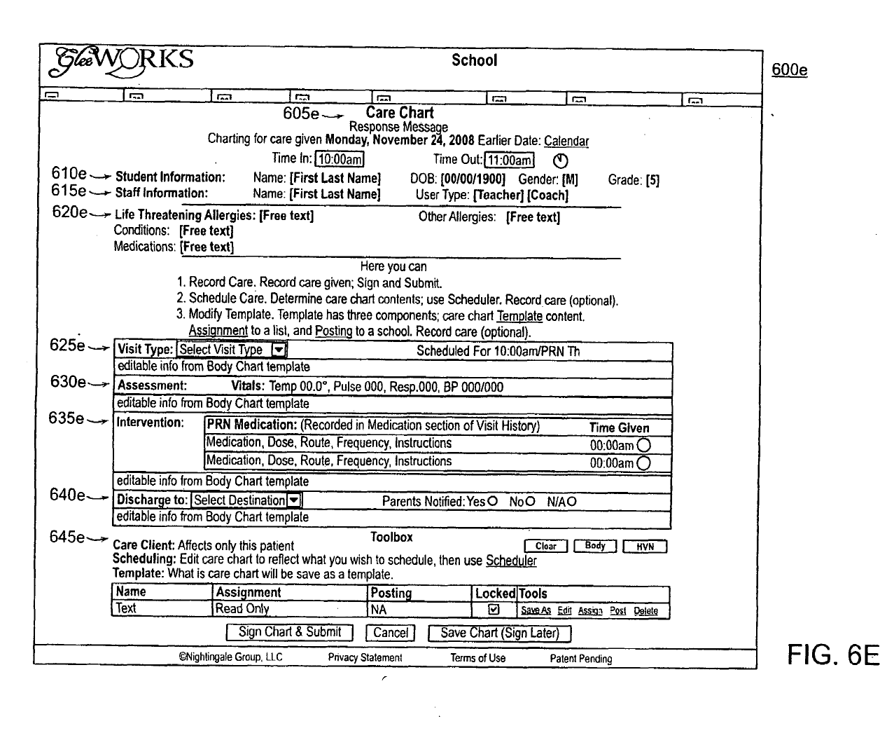

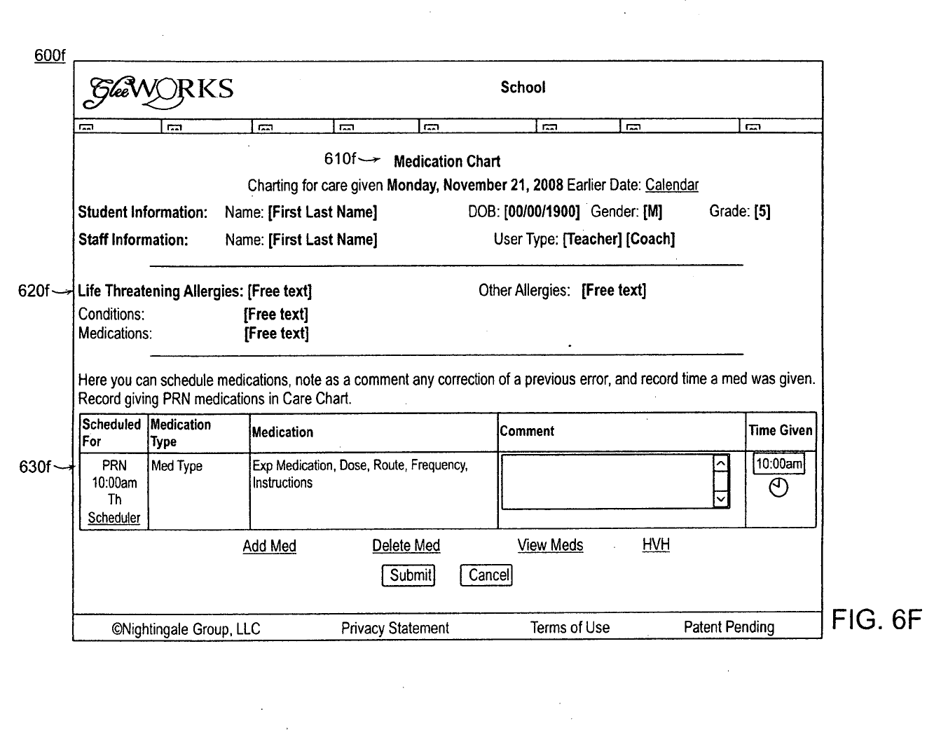

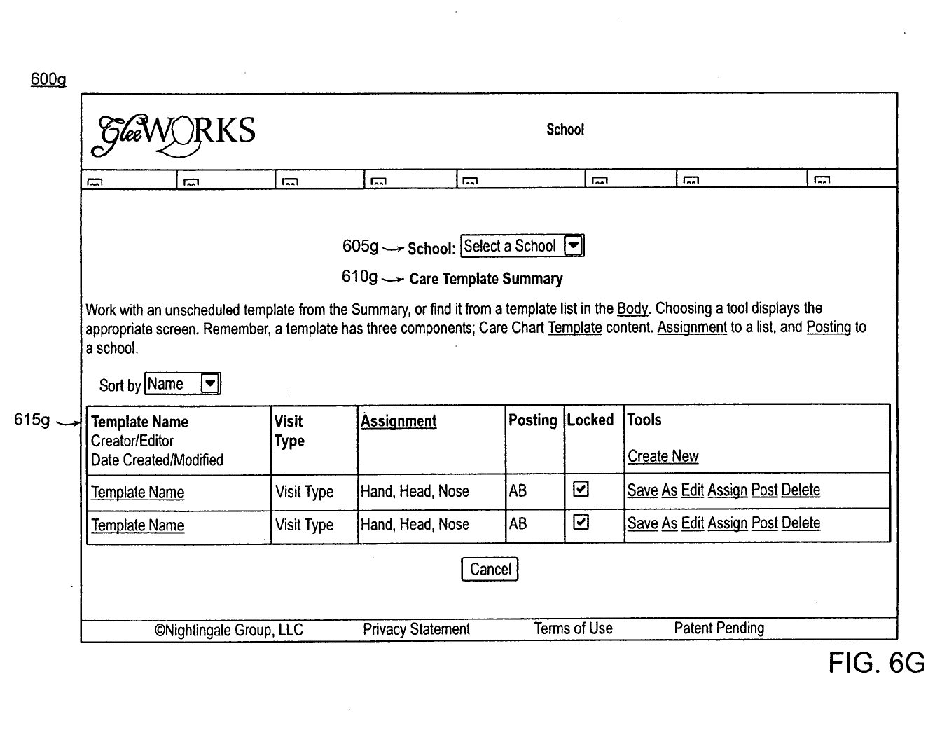

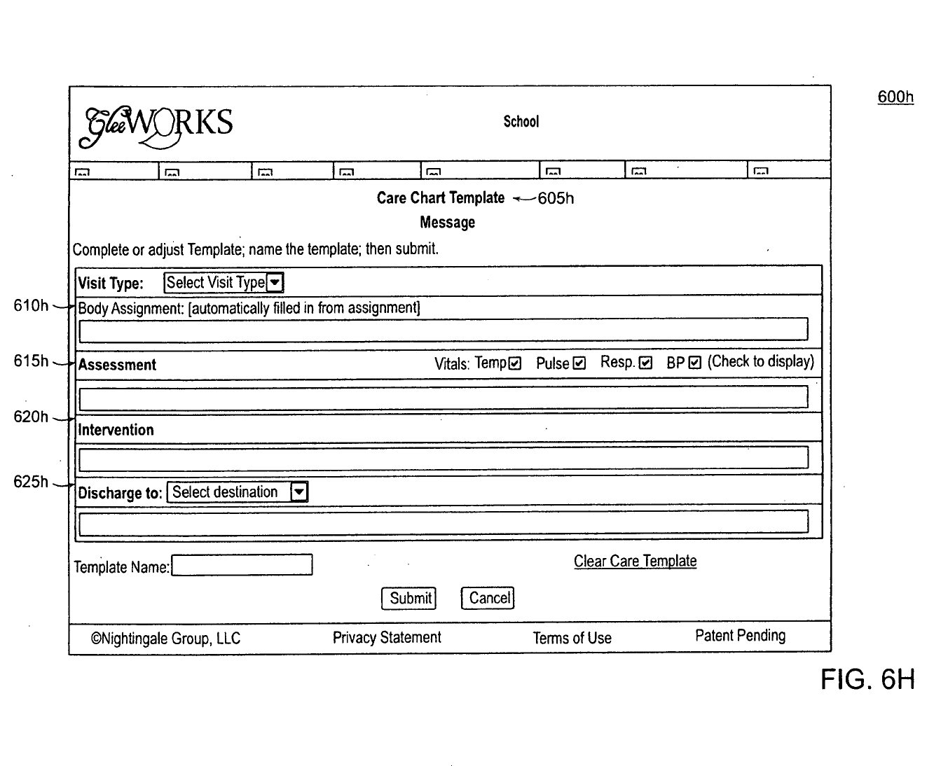

FIG. 6A illustrates an exemplary screen shot of a user interface 600a for healthcare information management. The user interface 600a includes a search function for patients 605a and a patient manager for users 610a. The user can utilize the search function for patients 605a to find users and user groups. The healthcare professional utilizes the patient manager for users 610a to manage appointments. The user can utilize the user interface 600a to manage healthcare information associated with users (e g., input healthcare information, modify healthcare information, etc.).

FIG. 6B illustrates an exemplary screen shot of a user interface 600b. The user interface 600b includes health visit history information 605b, staff information 610b, life threatening allergy information 615b, medication information 620b, pro re nata (PRN) medication information 625b, care chart information 630b, and visit type information 635b. The health information can be inputted and/or utilized by healthcare professionals. The user can utilize the user interface 600b to input information, requests for information, and/or responses to requests for information.

FIG. 6C illustrates an exemplary screen shot of a user interface 600c. The user interface 600c includes a doctor medication permission information form 605c. The doctor medication permission information form 605c enables the healthcare professional to provide the requested additional information (in this example, medications and e-signature of the doctor).

FIG. 6D illustrates an exemplary screen shot of a user interface 600d. The user interface 600d includes a body with form templates 605d, a front body diagram 610d, and a back body diagram 615d. The user can provide information and/or additional information in response to a request utilizing the user interface 600d. In this example, the user can indicate pain and/or other healthcare issues with a body utilizing the user interface 600d.

FIG. 6E illustrates an exemplary screen shot of a user interface 600e. The user interface 600e includes a care chart 605e that includes student information 610e, staff information 615e, life threatening allergies information 620e, visit type information 625e, assessment information 630e, intervention information 635e, discharge information 640e, and care chart information 645e. The user can provide information, provide additional information in response to a request, and/or request information utilizing the user interface 600e.

FIG. 6F illustrates an exemplary screen shot of a user interface 600f. The user interface 600f includes a medication chart 610f that includes life threatening allergies information 620f and medication schedule information 630f. The user can provide information and or additional information in response to a request utilizing the user interface 600f.

FIG. 6G illustrates an exemplary screen shot of a user interface 600g. The user interface 600g includes a school drop down list 605g and a care template summary 610g. The care template summary 610g includes a template name list 615g.

FIG. 6H illustrates an exemplary screen shot of a user interface 600h. The user interface 600h includes a care chart template 605h that includes a body assignment parameter 610h, an assessment parameter 615h, an intervention parameter 620h, and a discharge drop down list parameter 625h. The user can generate care chart information form templates utilizing the user interface 600h.

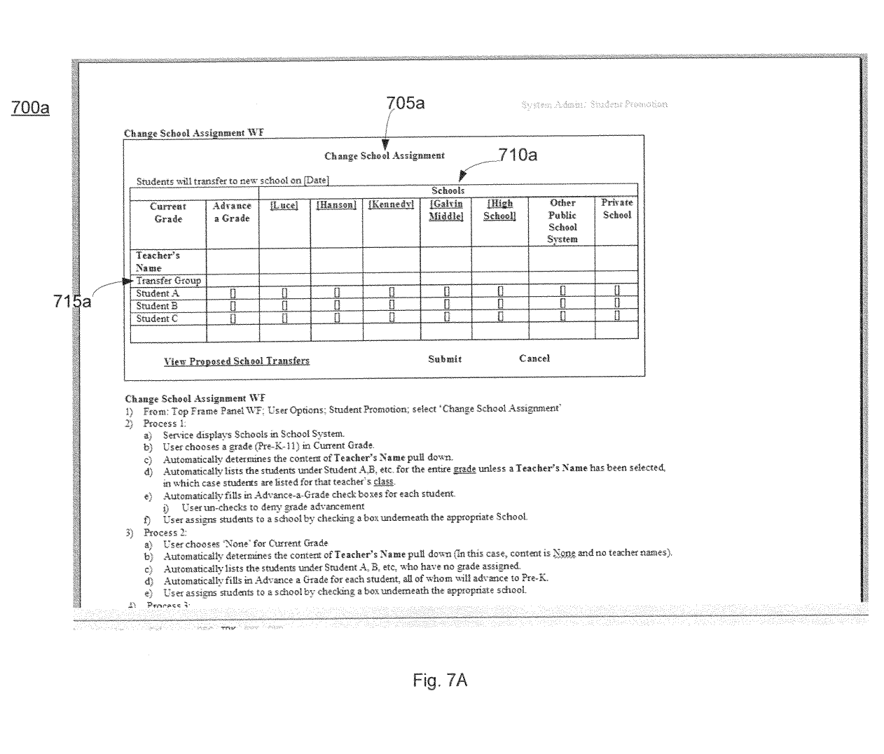

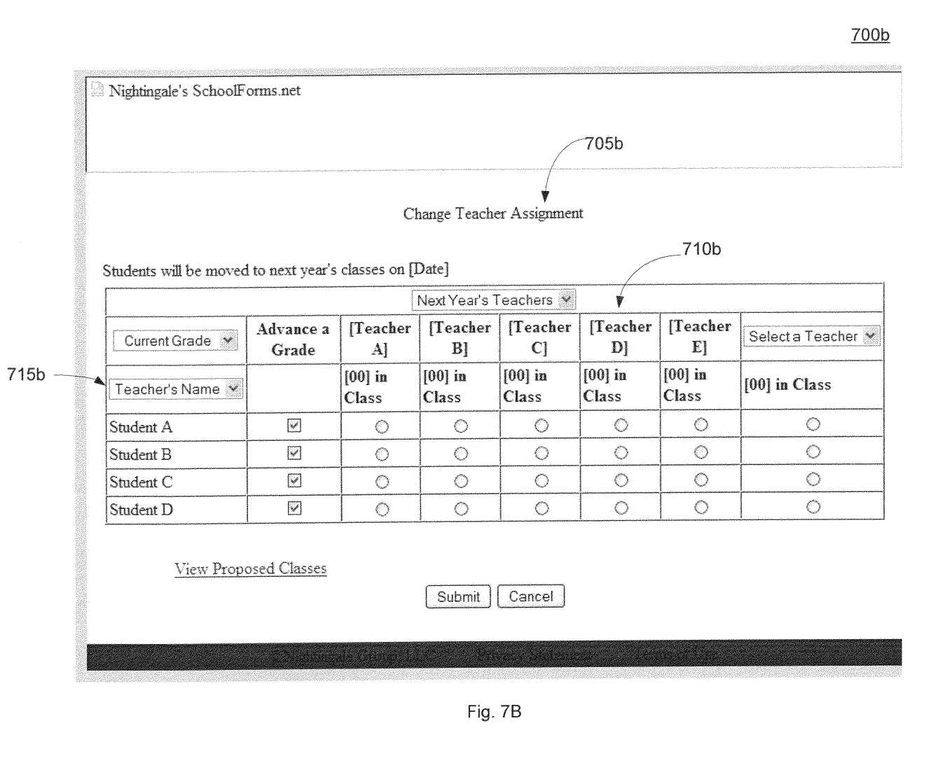

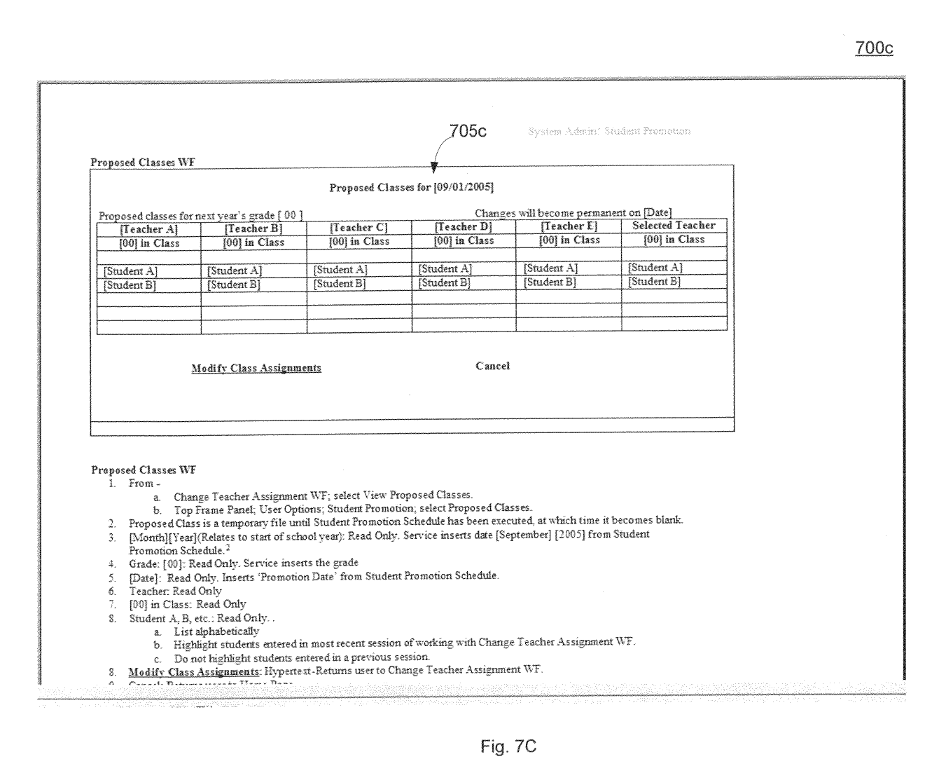

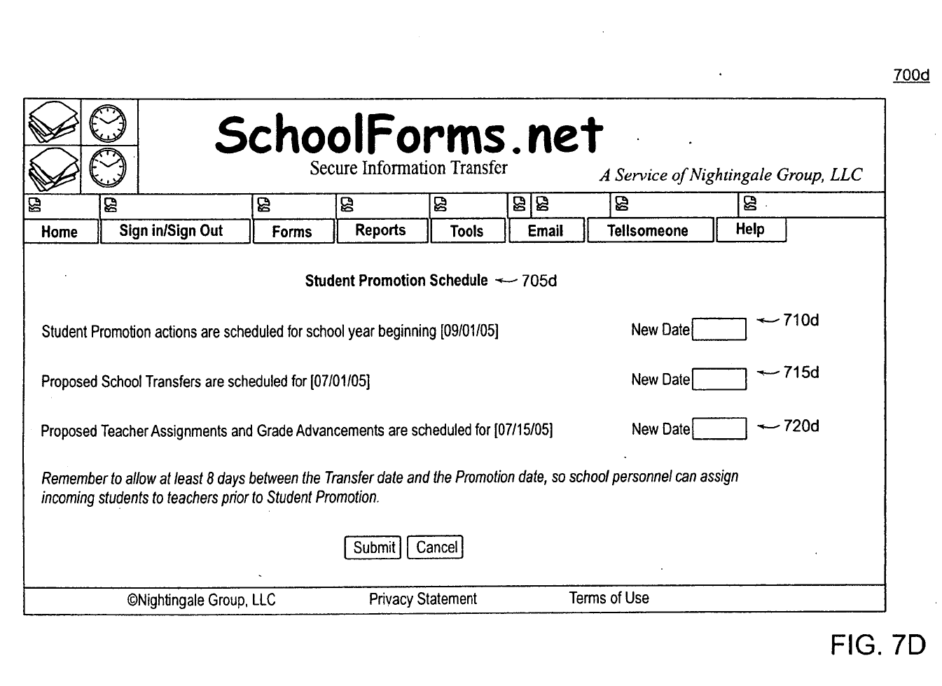

FIG. 7A illustrates an exemplary screen shot of a user interface 700a. The user interface 700a includes change school assignment information 705a, school information 710a, and transfer group information 715a. The user can provide information and or additional information in response to a request utilizing the user interface 700a (in this example, school assignments for students).

FIG. 7B illustrates an exemplary screen shot of a user interface 700b. The user interface 700b includes change teacher assignment information 705b, teacher information 710b, and a teacher name information 715b. The user can provide information and/or additional information in response to a request utilizing the user interface 700b (in this example, school assignments for teachers).

FIG. 7C illustrates an exemplary screen shot of a user interface 700c. The user interface 700c includes proposed class assignment information 705c. The user can be provided requested information utilizing the user interface 700c (in this example, the proposed class assignment information).

FIG. 7D illustrates an exemplary screen shot of a user interface 700d. The user interface 700d includes student promotion schedule information 705d, proposed promotion date information 710d, proposed school transfer date information 715d, and proposed teacher assignment and grade advancement date information 720d. The user can provide information and/or additional information in response to a request utilizing the user interface 700a (in this example, student promotion schedules are provided).

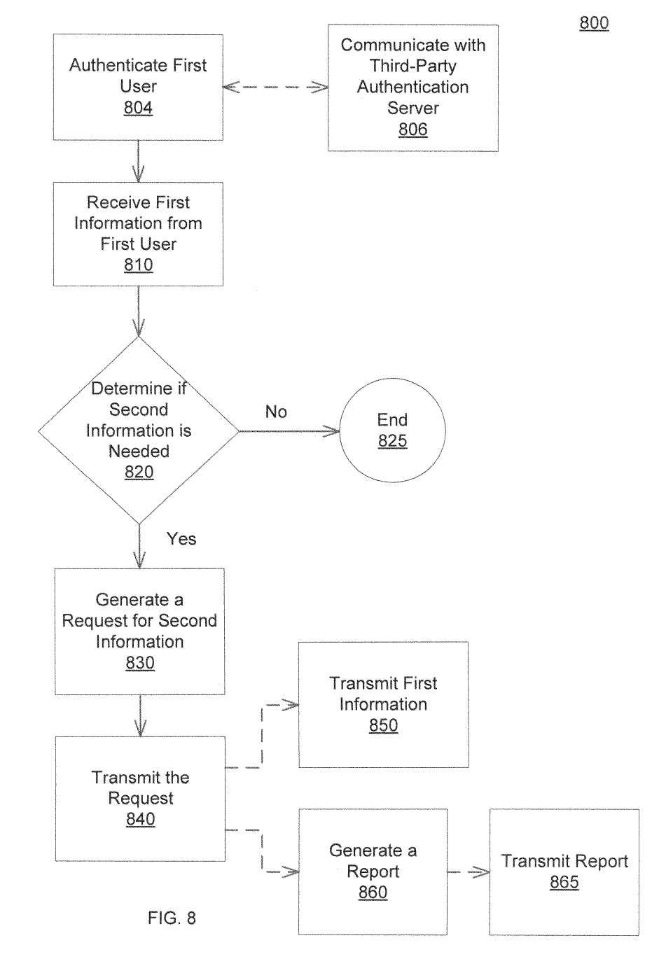

FIG. 8 illustrates an exemplary flow chart 800 utilizing the information and form access server 230 of FIG. 2b. The access control module 232 authenticates (804) a first user. The communication module 231 receives (810) first information from the first user. The form control module 233 determines (820) if second information is needed to complete an information form based on the first information and the form parameter associated with the information form. If no additional information is needed, the form control module 233 ends (825) the processing. If additional information is needed, the form control module 233 generates (830) a request for a second user for second information based on the determination of the second information and the second access control parameter associated with the second information. The communication module 231 transmits (840) the request for second information to the second user.

In some examples the access control module 232 communicates (806) via the communication module 231 with a third party authentication server to authenticate the first user (e.g., the third-party access control and information server 140). The access control module 232 can, for example, add, delete, and/or edit users managed on the third party authentication server.

In other examples the communication module 231 transmits (850) the first information to the second user or a third user. The access control module 232 can, for example) access the first information based on an authentication request and/or a information request from one of the users (e.g., the first user, the second user, the third user, etc.).

In some examples the report generation module 238 generates (860) a report. The communication module 231 transmits (865) the report. The report generation module 238 can generate (860) the report based on a report request from a user and/or access control parameters associated with the requested information.

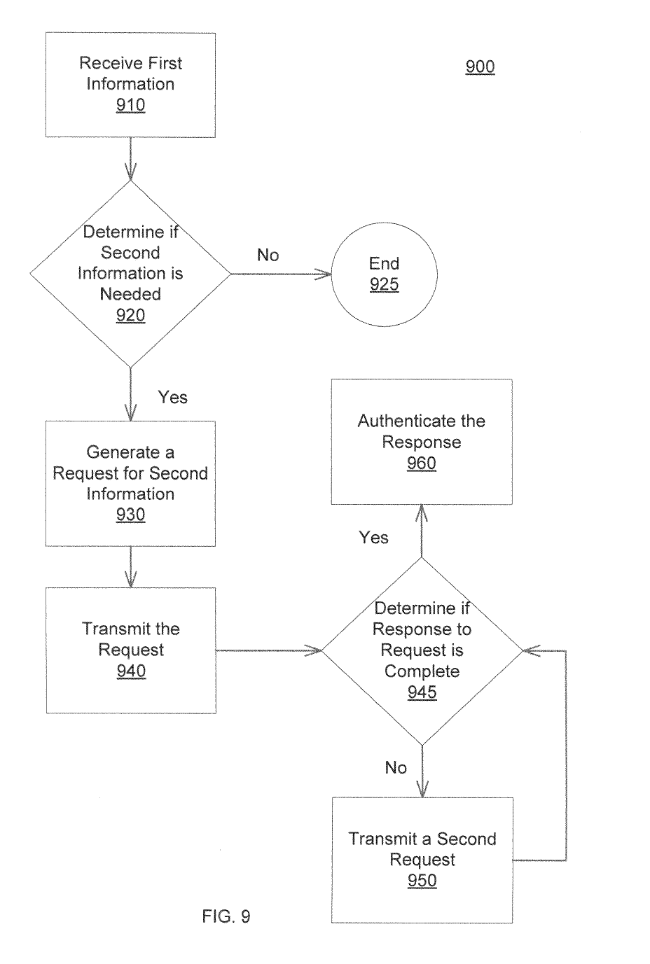

FIG. 9 illustrates an exemplary flow chart 900 utilizing the information and form access server 230 of FIG. 2B. The access control module 232 authenticates (904) a first user. The communication module 231 receives (910) first information from the first user. The form control module 233 determines (920) if second information is needed to complete an information form based on the first information and the form parameter associated with the information form. If no additional information is needed, the form control module 233 ends (925) the processing. If additional information is needed, the form control module 233 generates (930) a request for a second user for second information based on the determinations of the second information and the second access control parameter associated with the second information. The communication module 231 transmits (940) the request for second information to the second user. The student information module 237 determines (945) if a response to the request for the second information from the second user is complete. If the response is complete, the access control module 232 authenticates (960) the response. If the response is not complete, the communication module 231 transmits (950) a second request for the second information to the second user based on the determination if the second user completed the request for the second information. After the transmission (950) of the second request, the student information module 237 continues to determine (945) if the response to the request for the second information is complete (e.g., after a pre-determined time period, after a dynamically generated time period, etc.).

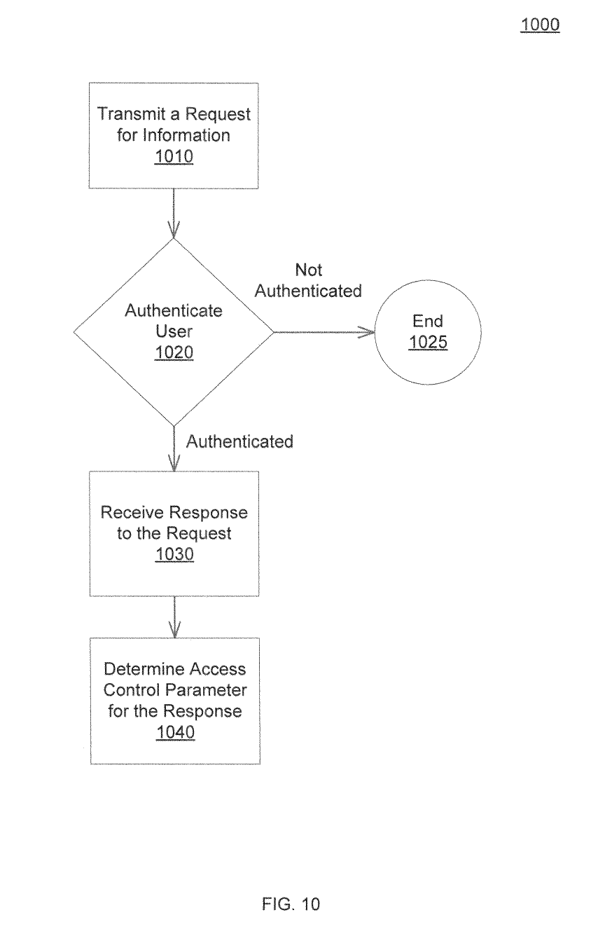

FIG. 10 illustrates an exemplary flow chart 1000 for an information request via the information and form access server 230 of FIG. 2B. The communication module 231 transmits (1010) a request for information to a second user. The access control module 232 authenticates (1020) the second user based on an authentication request from the second user. If the second user is not authenticated, the processing of the flow chart 1000 ends (1025). If the second user is authenticated, the communication module (231) receives the response to the request for the information from the second user based on the authentication of the second user. The access control module 232 determines an access control parameter for the response to the request for the information based on the user type associated with one or more users.

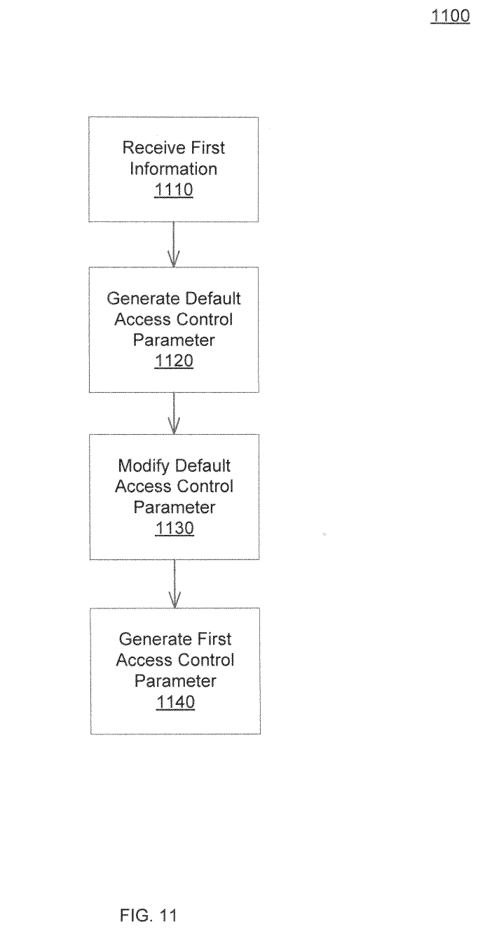

FIG. 11 illustrates an exemplary flow chart 1100 that generates access control parameters via the information and form access 230 of FIG. 2B. The communication module 231 receives (1110) first information from a first user. The access control module 232 generates (1120) a default access control parameter based on an access control template associated with one or more user types of the one or more users (e.g., the first user, the second user, the third user, etc.). The access control module 232 modifies (1130) the default access control parameter based on an access request from the user. The access control module 232 generates (1140) a first access control parameter associated with the first information based on the modified default access control parameter.

Referring back to FIG. 8 and to Table 4 below, for example, the access control module 232 authenticates (804) a first user (in this example, a teacher). The communication module 231 receives (810) first information from the first user (in this example, a field trip request form for all students in the teacher's class). The form control module 233 determines (820) if second information is needed to complete an information form based on the first information and the form parameter associated with the information form (in this example, the information form is a field trip request information form and additional information is needed from the parent, i.e., parental approval). In this example, the student information, the parental contact information, and the emergency contact information are automatically retried from the storage device 240. Since additional information is needed, the form control module 233 generates (830) a request for the parent for second information, i e., the parental approval, based on the determination of the second information and the second access control parameter associated with the second information (in this example, the parent is the only user with e-sign access for the field trip request information form). The communication module 231 transmits (840) the request for the parental approval to the parent.

TABLE 4
Exemplary Field Trip Request Information Form

| Form Parameters | Information | Status |
|---|---|---|
| Student Information | Joe Smith . . . | Complete |
| Parental Contact Information | Jill and John Smith . . . | Complete |
| Emergency Contact Information | Jill Smith . . . | Complete |
| Parental Approval | | Incomplete |

Although the description of the system 100 of FIG. 1 herein utilizes a school as the example, the system 100 can be utilized by any type of organization (e.g., a company, a community based organization, etc.). For example, a company utilizes the system 100 for human resource forms and information access. As another example, a volunteer organization utilizes the system 100 to track volunteer forms and provide information access for volunteer information and activities,

In other examples, the system 100 can be used for the administration of school activities. The administration can include the collection and dissemination of information. The information can include activities, medical history, classes assigned, personal information, sports activities, and/or any other type of school related activity. For example, the system 100 can be utilized for yearly requests for basic information, such as health information, emergency information, extracurricular activities, athletic activities, lunch programs, and bussing, for students. The system 100 can analyze the stored information for a student and determine what, if any, information needs to be confirmed (e.g., allergy confirmation, emergency contacts, etc.), what, if any, additional information is needed, and/or what, if any, new information is needed for the yearly information (e.g., new sports, address change requires new bussing information, etc.).

As an example of an advantage of the technology, a school generally processes 15-29 forms per student per year. Based on an analysis of several schools, over 60% of the information on these 15-29 forms was requested on more than one form. In this regard, the technology can advantageously reduce the time required to enter in this redundant information (e.g., student name, parent name, home room teacher, emergency contact, etc.) by reusing stored information and associating this stored information with the information needed in the form. Based on a further analysis of several schools, the schools already had stored over 80% of the health information requested on health forms. In this regard, the technology can advantageously reduce the time required to enter in this redundant health information (e.g., allergies, medicines, primary doctor, specialty doctor, etc.) by reusing stored information and associating the stored information with the health information needed for the form.

As a further example of the technology, the school generally sends these 15-29 forms per student per year in paper form for completion (i.e., blank forms for completion). The paper forms for each students are then generally filled out by a parent, guardian, or health professional and returned to the school. A school administrator then either checks the forms and fills the forms in the paper format (i.e., files the forms in a filing cabinet) or enters in the pertinent information into a database. This manual, paper intensive process is time consuming and as discussed above, redundant. For example, an analysis of this process indicates that this manual, paper intensive process generally takes 40-60 minutes per form per student. On average, the school takes 24 minutes, a health professional, if applicable, takes 20 minutes, and a parent takes 16 minutes per form per student. In other words, for a school with 200 students, the schools spends 72,000 minutes (1,200 hours) to 139,200 minutes (2,320 hours) per year on forms based on 15-29 forms per student per year. This analysis does not include the cost of the paper for the forms and the mailing cost, if any.

This technology can advantageously reduce the processing time, on average, for each form per student to 6 minutes (e.g., 2 minutes for each user) via the information request and access system and method described herein. In this regard, the school with 2000 students can reduce the time spend to 6,000 minutes (100 hours) to 11,600 minutes (193 hours) based on 15-29 forms per student per year.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network Information carriers suitable for embodying computer program instructions and data include all forms of non-volatile memory, including by way of example semiconductor memory devices The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e g., interact with a user interface element). Other kinds of devices can be used to provide for interaction with a user. Other devices can, for example, be feedback provided to the user in any form of sensory feedback (e.g. visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and or wireless networks.

The system can include clients and servers. A client and a server are generally remote from each other and typically interact through a communication network. The relationship of client and server arises by virtue of computer programs running on the respective computers and having a client-server relationship to each other.

The communication network can include, for example, a packet-based network and/or a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The communication device can include, for example, a computer, a computer with a browser device, a telephone, an IP phone, a mobile device (e.g., cellular phone, personal digital assistant (PDA) device, laptop computer, electronic mail device), and/or other type of communication device. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for generating a request for information, comprising:
receiving, via a communication module, first information from a first user;
determining, by a form control module, if second information is needed to complete an information form based on the first information and a form parameter associated with the information form;
generating, by the form control module, a request to a second user for second information based on the determination of the second information and a second access control parameter associated with the second information; and
transmitting, via the communication module, the request for second information to the second user.

2. The method of claim 1, further comprising transmitting, via the communication module, the first information to a third user based on a first access control parameter and a transmission request from the third user.

3. The method of claim 2, further comprising determining, by an access control module, the first access control parameter associated with the first information based on one or more user types associated with one or more users.

4. The method of claim 3, wherein the one or more user types comprising a student, a parent, a teacher, an athletic administrator, a school administrator, a healthcare professional, or any combination thereof.

5. The method of claim 1, further comprising:
determining, by a student information module, if a response to the request for the second information from the second user is complete; and
transmitting, via the communication module, a second request for the second information to the second user based on the determination if the second user completed the request for the second information.

6. The method of claim 1, further comprising:
receiving, via the communication module, an authentication request from the second user; and
authenticating, by an access control module, the second user based on the authentication request.

7. The method of claim 6, further comprising:
receiving, via the communication module, a response to the request for the second information based on the authentication of the second user; and
determining, by the access control module, a second access control parameter for the response to the request for the second information based on the user type associated with the one or more users.

8. The method of claim 1, further comprising selecting, by a form creation module, the information form from one or more predetermined information forms based on the first information and a user type associated with the first user.

9. The method of claim 8, wherein the one or more predetermined information forms comprising a parent form, a student form, an athletics form, a health form, or any combination thereof.

10. The method of claim 1, further comprising:
generating, by an access control module, a default access control parameter based on an access control template associated with one or more user types of one or more users;
modifying, by the access control module, the default access control parameter based on an access request from the first user; and
generating by the access control module, a first access control parameter associated with the first information based on the modified default access control parameter.

11. The method of claim 1, further comprising:
generating, by a report generation module, a report based on the first information, a report request from a third user, and a first access control parameter; and
transmitting, via the communication module, the report to the third user based on the report request and the first access control parameter.

12. A computer program product, tangibly embodied in an information carrier, the computer program product including instructions being operable to cause a data processing apparatus to:
receive first information from a first user;
determine if second information is needed to complete an information form based on the first information and a form parameter associated with the information form;
generate a request to a second user for second information based on the determination of the second information and a second access control parameter associated with the second information; and
transmit the request for second information to the second user.

13. A system for generating a request for information, comprising:
a communication module to:
receive first information from a first user, and
transmit a request for second information to a second user; and
a form control module to:
determine if second information is needed to complete an information form based on the first information and a form parameter associated with the information form, and
generate the request for second information to the second user based on the determination of the second information and a second access control parameter associated with the second user.

14. The system of claim 13, further comprising the communication module further to transmit the first information to a third user based on a first access control parameter and a transmission request from the third user.

15. The system of claim 14, further comprising an access control module to determine the first access control parameter associated with the first information based on one or more user types associated with one or more users.

16. The method of claim 13, further comprising:
a student information module to determine if a response to the request for the second information from the second user is complete; and
the communication module further to transmit a second request for the second information to the second user based on the determination if the second user completed the request for the second information.

17. The system of claim 13, further comprising:
the communication module further to receive an authentication request from the second user; and
an access control module to authenticate the second user based on the authentication request.

18. The system of claim 17, further comprising:
the communication module further to receive a response to the request for the second information based on the authentication of the second user; and
the access control module further to determine a second access control parameter for the response to the request for the second information based on the user type associated with the one or more users.

19. The system of claim 13, further comprising a form creation module to select the information form from one or more predetermined information forms based on the first information and a user type associated with the first user.

20. The system of claim 13, further comprising:
an access control module to:
generate a default access control parameter based on an access control template associated with one or more user types of one or more users;
modify the default access control parameter based on an access request from the first user; and
generate a first access control parameter associated with the first information based on the modified default access control parameter.

21. The system of claim 13, further comprising:
a report generation module to generate a report based on the first information, a report request from a third user, and a first access control parameter; and
the communication module further to transmit the report to the third user based on the report request and the first access control parameter.

22. A system for generating a request for information, the system comprising:
means for receiving first information from a first user;
means for determining if second information is needed to complete an information form based on the first information and a form parameter associated with the information form;
means for generating a request to a second user for second information based on the determination of the second information and a second access control parameter associated with the second information; and
means for transmitting the request for second information to the second user.
